(19) United States
(12) Patent Application Publication
(10) Pub. No.: US 2026/0339242 A1
(43) Pub. Date: Oct. 29, 2026

(54) FIXING DEVICE AND IMAGE FORMING APPARATUS

(71) Applicant: CANON KABUSHIKI KAISHA, Tokyo (JP)

(72) Inventors: HIROSHI MIYAMOTO, Saitama (JP); SUGURU TAKEUCHI, Chiba (JP); YASUHARU TORATANI, Chiba (JP); KIYONORI SOTOME, Ibaraki (JP); MASAKI SUDA, Chiba (JP)

(21) Appl. No.: 19/655,914

(22) Filed: Apr. 23, 2026

(30) Foreign Application Priority Data
Apr. 26, 2025 (JP) 2025-073788
Apr. 18, 2026 (JP) 2026-069112

(51) Int. Cl. G03G 15/20; G03G 21/20

(52) U.S. Cl. CPC G03G 15/205; G03G 15/2032; G03G 15/2064; G03G 21/206; G03G 2215/2038; G03G 2221/1645

(57) ABSTRACT

A fixing device includes an endless belt, a heating member to heat the belt, a heater to heat the heating member, a pressing member to form a fixing nip, a first output portion to output a signal corresponding to a temperature of the heating member, and a second output portion to output a signal corresponding to a temperature of a detection target different from the heating member. A controller controls so as to change an operation setting of the fixing device, in which the fixing device shifts from a state in which heating of the heater is stopped to a state in which a toner image is capable of being fixed to a recording material by the fixing belt being heated by the heating member in a period of start-up of the fixing device based on the signal outputted by the second output portion.

### BACKGROUND

### Field of the Technology

The present invention relates to a fixing device which heats a toner image on a recording material, and an image forming apparatus using an electrophotographic type or an electrostatic recording type such as a copying machine, a printer, and a facsimile device or a multifunction machine provided with a plurality of functions of these, which is provided with the fixing device.

### Description of the Related Art

In an image forming apparatus such as a copy machine using an electrophotographic type or an electrostatic recording type, forming a toner image on a recording material having a sheet shape, and fixing the toner image on the recording material onto the recording material by heating and pressing the toner image with a fixing device (fixing operation) are performed.

As the fixing device, for example, a configuration using a fixing belt constituted by an endless belt as a fixing member (rotatable heating member) which heats the toner image on the recording material (belt fixing device, belt heating type) is known. In Japanese Patent Application Laid-Open No. 2013-156334, a fixing device including a fixing belt (heating belt) as a fixing member, a fixing pad as a heating member which contacts an inner peripheral surface of the fixing belt, and a heat source which heats the fixing pad is described. In addition, this fixing device includes a heating roller (heating roll) as the heating member which contacts the inner peripheral surface of the fixing belt and a heat source which heats the heating roller. Further, this fixing device includes a pressing roller (pressing roll) which forms a fixing nip portion by pressing the fixing belt from an outer peripheral surface side thereof against the fixing pad. And by heating the fixing belt using the fixing pad and the heating roller, and by nipping and conveying the recording material, which bears an unfixed toner image, in the fixing nip portion, this fixing device fixes the toner image onto the recording material with heat and pressure.

In addition, as to a temperature control of a fixing device, in Japanese Patent Application Laid-Open No. H10-26901, a configuration in which a target temperature of a fixing device is set depending on an initial temperature of a surface of a rotatable heating member during turning a power source on is described.

### SUMMARY

According to an aspect of the present invention, there is provided a fixing device for fixing a toner image onto a recording material, the fixing device comprising: an endless fixing belt; a heating member configured to heat the belt; a heat source configured to heat the heating member; a pressing member configured to form a fixing nip portion with the fixing belt and to nip and convey the recording material with the fixing belt at the fixing nip portion; a first output portion configured to output a signal corresponding to a temperature of the heating member; a second output portion configured to output a signal corresponding to a temperature of a detection target different from the heating member; and a controller configured to control so as to change an operation setting of the fixing device, in which the fixing device shifts from a state in which heating of the heat source is stopped to a state in which the toner image is capable of being fixed to the recording material by the fixing belt being heated by the heating member, in a period of start-up of the fixing device based on the signal outputted by the second output portion.

Further features of the present invention will become apparent from the following description of exemplary embodiments with reference to the attached drawings.

### BRIEF DESCRIPTION OF THE DRAWINGS

FIG. 1 is a cross-sectional view illustrating an outline configuration of an image forming apparatus.

FIG. 2 is a cross-sectional view illustrating an outline configuration of a fixing device.

FIG. 3 is a block diagram illustrating a control configuration of the image forming apparatus.

FIG. 4 is a graph view showing an example of a transition of temperature of each member during start-up of the fixing device.

FIG. 5 is a graph view showing an example of the transition of temperature of each member during start-up of the fixing device.

FIG. 6 is a graph view showing an example of a setting of a heat storing time with respect to a heat storage index temperature during start-up of the fixing device.

FIG. 7 is a flowchart diagram of an example of a start-up control of the fixing device.

FIG. 8, part (a) and part (b), includes graph views showing an effect due to a control of the heat storing time during start-up of the fixing device.

FIG. 9 is a graph view showing an example of the transition of temperature of each member during start-up of the fixing device.

FIG. 10 is a graph view showing an example of the transition of temperature of each member during start-up of the fixing device.

FIG. 11 is a flowchart diagram of an example of a control which causes a pressing roller to be in contact with a fixing belt during start-up of the fixing device.

FIG. 12, part (a) and part (b), includes graph views showing an effect due to the contact of the pressing roller during start-up of the fixing device.

FIG. 13 is a schematic view of a vicinity of the fixing device.

FIG. 14 is a graph view showing an example of a setting of a target temperature of a heating roller during fixing operation.

FIG. 15 is a flowchart diagram of an example of a control of the target temperature of the heating roller during fixing operation.

FIG. 16 is a graph view showing an example of the setting of the target temperature of the heating roller during fixing operation.

FIG. 17 is a flowchart diagram of an example of a control of the target temperature of the heating roller during fixing operation.

FIG. 18, part (a) and part (b), includes graph views showing effects due to the control of the target temperature of the heating roller during fixing operation.

FIG. 19 is an explanatory view for describing classification of states of the fixing device.

FIG. 20 is a graph view showing an effect due to the control of the target temperature of the heating roller during fixing operation.

### DESCRIPTION OF THE EMBODIMENTS

Hereinafter, a fixing device and an image forming apparatus according to the present invention will be described in more detail with reference to the drawings.

### Embodiment 1

### <Configuration of an Image Forming Apparatus>

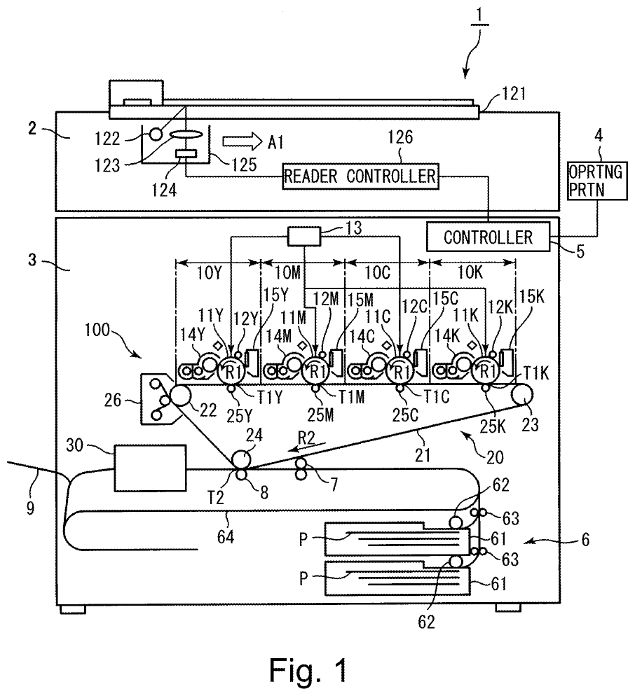

First, a configuration of an image forming apparatus in the present Embodiment will be described. FIG. 1 is a cross-sectional view illustrating an outline configuration of an image forming apparatus 1 in the present Embodiment. In the present Embodiment, the image forming apparatus 1 is an image forming apparatus of tandem type employing an intermediary transfer type, which is capable of forming a full-color image on a recording material P having a sheet shape using an electrophotographic type.

Incidentally, as to the image forming apparatus 1 and elements thereof, a front side of a paper of FIG. 1 is defined as a “front (front surface)” side, and a back side of the paper of FIG. 1 is defined as a “rear (back surface)” side. A direction perpendicular to the paper of FIG. 1 connecting the front side and the rear side of the image forming apparatus 1 (front-rear direction) is assumed to be approximately parallel to a rotational axis direction of a photosensitive drum 11, which will be described below. In addition, as the recording material (recording medium, transfer material, sheet) on which the image is formed in the image forming apparatus 1, paper is typically used. Therefore, here, the recording material is sometimes referred to as a “paper”, a “sheet”, etc. However, the recording material is not limited to paper, but may be material formed of material other than paper such as a plastic sheet or material including material other than paper. In addition, a type of the recording material (paper type) includes arbitrary information, with which the recording material is distinguishable, such as an attribute based on a general characteristic such as a plain paper, a coated paper, a thick paper, and a synthetic paper (so-called, paper type category), a numerical value and/or a numerical value range such as a basis weight and a thickness, and a brand (including a maker, a product number, etc.). Generally, the type of the recording material is often specified by the paper type category and the thickness (or the basis weight).

The image forming apparatus 1 includes an image reading portion (reader portion) 2 and a printer portion (image forming apparatus main assembly) 3. The image reading portion 2 reads an original placed on an original table glass 121. The image reading portion 2 includes an optical system unit 125 provided with a light source 122, an optical system member 123 such as a lens, and a CCD sensor 124. In the optical system unit 125, light irradiated from the light source 122 is reflected by the original, and forms an image on the CCD sensor 124 via the optical system member 123 such as the lens. The optical system unit 125 in this manner converts the original, by being moved in a direction of an arrow A1 in FIG. 1 and scanning the original, into an electric signal data sequence for each line. An image signal obtained by the CCD sensor 124 is sent, via a reader control portion 126, to a control portion 5 provided in the printer portion 3. And in the control portion 5, to this image signal, image processing adapted to an image forming portion 100, which will be described below, is performed. In addition, as the image signal, the control portion 5 may also receive an external input from an external host device such as a print server (for example, a personal computer).

The printer portion 3 includes, as a plurality of image forming units, four image forming units 10Y, 10M, 10C, and 10K which form images of a yellow color (Y), a magenta color (M), a cyan color (C), and a black color (K), respectively. Incidentally, elements having the same or corresponding functions or configurations, which are provided for each color, may be described collectively by omitting Y, M, C and K at the ends of reference numerals indicating that the element is for either one of the colors. The image forming unit 10 is constituted by a photosensitive drum 11 (11Y, 11M, 11C, 11K), which will be described below, a charging roller 12 (12Y, 12M, 12C, 12K), an exposure device 13, a developing device 14 (14Y, 14M, 14C, 14K), a drum cleaning device 15 (15Y, 15M, 15C, 15K), etc. In the present Embodiment, the exposure device 13 is configured as one unit which irradiates the photosensitive drum 11 in each image forming unit 10 with light. However, the exposure device 13 may be provided independently for each image forming unit 10. In each image forming unit 10, image formation is performed based on the image signal described above.

The photosensitive drum 11, which is a photosensitive member (electrophotographic photosensitive member) having a drum shape (cylindrical shape), as a first image bearing member is rotationally driven in a direction of an arrow R1 (counterclockwise direction) in FIG. 1. A surface of the rotating photosensitive drum 11 is uniformly charged, by the charging roller 12, which is a charging member (charger) having a roller shape, as a charging means, to a predetermined potential of predetermined polarity (negative polarity in the present Embodiment). The charged surface of the photosensitive drum 11 is scanned and exposed in accordance with the image signal by the exposure device 13, and an electrostatic latent image (electrostatic image) is formed on the photosensitive drum 11. The image signal is converted into a laser beam, which is subjected to pulse width modulation (PWM), controlled by the control portion 5. The exposure device 13 is configured to include a polygon scanner, scans the laser beam in accordance with the image signal, and irradiates the photosensitive drum 11 of each image forming unit 10 with the laser beam. The electrostatic latent image formed on the photosensitive drum 4 is developed (visualized) by toner as developer being supplied by the developing device 14 as a developing means, and a toner image (developer image) is formed on the photosensitive drum 11. In the present Embodiment, to an exposed portion on the photosensitive drum 11, in which an absolute value of the potential is decreased by being exposed after having been uniformly charged, the developing device 14 causes the toner charged to the same polarity as the charging polarity of the photosensitive drum 11 (negative polarity in the present Embodiment) to be adhered. In the present Embodiment, normal charging polarity of the toner, which is main charging polarity of the toner during development, is negative polarity.

So as to be opposite to the four photosensitive drums 11, an intermediary transfer unit 20 is disposed. The intermediary transfer unit 20 includes, as a second image bearing member, an intermediary transfer belt 21 which is an intermediary transfer member constituted by an endless belt. The intermediary transfer belt 21 is stretched around a driving roller 22, a tension roller 23, and a secondary transfer opposite roller 24 as a plurality of stretching rollers, and is stretched at predetermined tensile force. The intermediary transfer belt 21 is rotated (circulated), by the driving roller 22 being rotationally driven, in a direction of an arrow R2 (clockwise direction) in FIG. 1. On an inner peripheral surface side of the intermediary transfer belt 21, corresponding to the respective photosensitive drums 11Y, 11M, 11C, and 11K, primary transfer rollers 25Y, 25M, 25C, and 25K, which are primary transfer members having roller shapes as primary transfer means, are disposed. The primary transfer roller 25 is pressed toward the photosensitive drum 11 via the intermediary transfer belt 21, and forms a primary transfer portion (primary transfer nip portion) T1, which is a contacting portion between the photosensitive drum 11 and the intermediary transfer belt 21. The stretching rollers other than the driving roller 22 and each primary transfer roller 25 are rotated driven by the rotation of the intermediary transfer belt 21. The toner image formed on the photosensitive drum 11 is transferred (primarily transferred), in the primary transfer portion T1, onto the rotating intermediary transfer belt 21. During primary transfer, to the primary transfer roller 25, a primary transfer bias (primary transfer voltage) having opposite polarity to the normal charging polarity of the toner (positive polarity in the present Embodiment) is applied. As a result, the primary transfer roller 25 performs electric discharge from the inner peripheral surface of the intermediary transfer belt 21, and causes the toner image on the photosensitive drum 11 to be transferred onto the intermediary transfer belt 21. For example, during formation of a full-color image, toner images of respective colors of yellow, magenta, cyan, and black formed on the respective photosensitive drums 11Y, 11M, 11C, and 11K are sequentially transferred so as to be superimposed on the same image forming area on the intermediary transfer belt 21. The surface of the photosensitive drum 11 after the primary transfer is cleaned by the drum cleaning device 15 as a photosensitive member cleaning means.

On an outer peripheral surface side of the intermediary transfer belt 21, at a position opposite to the secondary transfer opposite roller 24 via the intermediary transfer belt 21, a secondary transfer roller 8, which is a secondary transfer member having a roller shape, as a secondary transfer means is disposed. The secondary transfer roller 8 is pressed toward the secondary transfer opposite roller 24 via the intermediary transfer belt 21, and forms a secondary transfer portion (secondary transfer nip portion) T2, which is a contacting portion between the intermediary transfer belt 21 and the secondary transfer roller 8. The toner image formed on the intermediary transfer belt 21 is transferred (secondarily transferred), in the secondary transfer portion T2, onto the recording material P which is being nipped and conveyed by the intermediary transfer belt 21 and the secondary transfer roller 8. During secondary transfer, to the secondary transfer roller 8, a secondary transfer bias (secondary transfer voltage) having opposite polarity to the normal charging polarity of the toner (positive polarity in the present Embodiment) is applied. As a result, the secondary transfer roller 8 forms a secondary transfer electric field in the secondary transfer portion T2, and causes the toner image on the intermediary transfer belt 21 to be transferred onto the recording material P. The surface of the intermediary transfer belt 21 after the secondary transfer is cleaned by a belt cleaning device 26 as an intermediary transfer member cleaning means. In the present Embodiment, the intermediary transfer unit 20 is configured to include the intermediary transfer belt 21, the stretching rollers 22, 23, and 24, each primary transfer roller 25, the belt cleaning device 26, etc.

The recording material P is fed from a feeding portion 6 as a feeding means, and is conveyed toward the secondary transfer portion T2. The feeding portion 6 is configured to include a cassette 61 as an accommodating portion, a feeding roller 62 as a feeding member, a conveyance roller 63 as a conveyance member, etc. The recording material P accommodated in the cassette 61 is separated one by one by the feeding roller 62, etc., and sent out from the cassette 61. This recording material P is conveyed, by the conveyance roller 63, to a registration roller pair (registration portion) 7 as a synchronizing conveyance member. The recording material P is conveyed, after being made to wait by the registration roller pair 7, with a timing being controlled in order to align positions between the toner image on the intermediary transfer belt 21 and the recording material P, to the secondary transfer portion T2 by the registration roller pair 7.

The recording material P, onto which the toner image has been transferred, is conveyed to a fixing device 30 which is an image heating device as a fixing means. The fixing device 30 heats and presses the recording material P bearing the unfixed toner image, and fixes (melts, sticks) the toner image onto the recording material P (fixing operation, fixing process). In a case of single-sided printing, the recording material P, to which the toner image has been fixed by passing through the fixing device 30, is thereafter discharged (output) to an outside of the image forming apparatus 1 (outside the machine), and is stacked on a discharge tray 9 as a discharging portion. In a case of double-sided printing, when the transfer and the fixing of the toner image to a first side (first side for image formation) of the recording material P are completed, the recording material P is conveyed to a reversing portion 64 provided inside the printer portion 3. And, the transfer and the fixing of the toner image to a second side (second side for image formation) of the recording material P, of which front and back sides have been reversed in the reversing portion 64, are performed. This recording material P is thereafter discharged outside the machine, and is stacked on the discharge tray 9.

In the present Embodiment, the image forming portion 100, which forms the toner image on the recording material P, is constituted by each image forming unit 10, the intermediary transfer unit 20, the secondary transfer roller 8, etc.

### <Configuration of the Fixing Device>

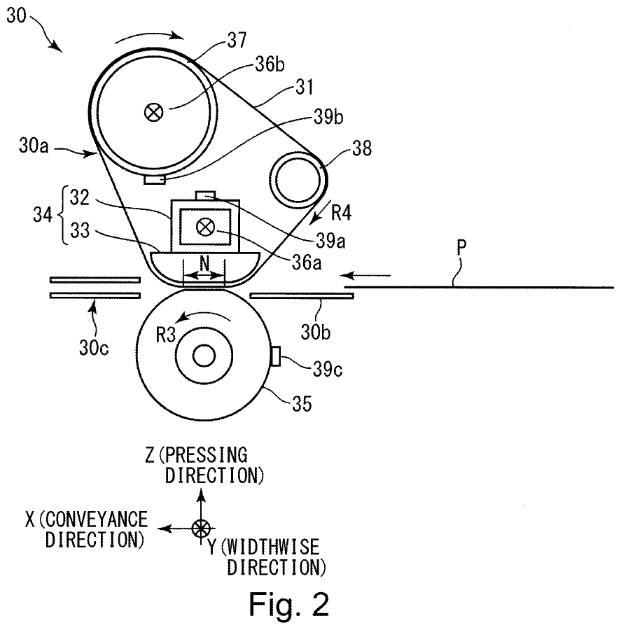

Next, a configuration of the fixing device 30 in the present Embodiment will be described. In the present Embodiment, the fixing device 30 is a fixing device of belt heating type. FIG. 2 is a cross-sectional view illustrating an outline configuration of the fixing device 30 in the present Embodiment (illustrating a cross section approximately perpendicular to a rotational axis direction of a heating roller 37, which will be described below).

In FIG. 2, an X direction indicates a conveyance direction of the recording material P, a Y direction indicates a widthwise direction perpendicular to the conveyance direction of the recording material P, and a Z direction indicates a direction perpendicular to both the X direction and the Y direction. The Y direction (widthwise direction of the recording material P) is approximately parallel to the rotational axis direction (a longitudinal direction) of the heating roller 37 and that of a pressing roller 35, which will be described below. In addition, the Z direction is approximately parallel to a direction (pressing direction), in which the recording material P is pressed by the pressing roller 35 against a pressing pad 33 via a fixing belt 31 as will be described below. In the present Embodiment, the fixing device 30 is disposed so that the Y direction becomes approximately parallel to the front-rear direction connecting the front side and the rear side of the image forming apparatus 1. In addition, in the present Embodiment, the fixing device 30 is disposed so that the Z direction becomes approximately parallel to a direction of gravity.

The fixing device 30 includes, as a fixing member, the fixing belt 31 which is a rotatable heating member constituted by a rotatable endless belt. In addition, the fixing device 30 includes the pressing pad (a fixing pad) 33 as a fixing member supporting member for supporting the fixing member, and a stay 32 as a supporting member for supporting the pressing pad 33. The stay 32 and the pressing pad 33 constitute a pad portion 34 as a first heating member. In addition, the fixing device 30 includes the heating roller 37 as a second heating member serving also as a stretching roller, and a steering roller 38 as a stretching roller. In addition, the fixing device 30 includes the pressing roller 35 as a pressing member (rotatable pressing member) disposed opposite to the fixing belt 31. In addition, the fixing device 30 includes a heater inside the stay (first heater) 36a as a first heating source, and a heater inside the heating roller (second heater) 36b as a second heating source. The fixing belt 31, the pad portion 34 (the stay 32, the pressing pad 33), the heating roller 37, the heater inside the stay 36a, the heater inside the heating roller 36b, and the steering roller 38 constitute a heating unit 30a which applies heat to the toner image on the recording material P. In addition, the fixing device 30 includes a first, a second, and a third temperature detecting element 39a, 39b, and 39c as temperature detecting means. Further, the fixing device 30 includes an entrance guide 30b, which guides the recording material P toward the fixing nip portion N, a separating guide 30c for separating the recording material P, which has passed through the fixing nip portion N, from the fixing belt 31, etc.

The fixing belt 31 is a member having a thin cylindrical shape with thermal conductivity and heat resistance. In the present Embodiment, the fixing belt 31 has a three-layer structure including a base layer, an elastic layer formed on an outer periphery of the base layer, and a releasing layer formed on an outer periphery of the elastic layer. In the present Embodiment, the base layer has a thickness of 80 μm, and a polyimide resin (PI) is used as material thereof. In addition, in the present Embodiment, the elastic layer has a thickness of 300 μm, and silicone rubber is used as material thereof. In addition, in the present Embodiment, the releasing layer has a thickness of 30 μm, and PFA (tetrafluoroethylene perfluoroalkoxyethylene copolymerization resin), which is fluororesin, is used as material thereof. The fixing belt 31 is stretched by the pressing pad 33, the heating roller 37, and the steering roller 38.

The pressing pad 33 is pressed against the pressing roller 35 across the fixing belt 31. The pressing pad 33 is supported by the stay 32. In the present Embodiment, as material of the pressing pad 33, LCP (liquid crystal polymer), which is material having heat resistance, is used. In addition, in the present Embodiment, between the pressing pad 33 and the fixing belt 31, a sliding member (not shown) is interposed. The sliding member is constituted by, for example, a releasing layer having releasing property, etc. In addition, in the present Embodiment, to an inner peripheral surface of the fixing belt 31, a lubricant is applied. By this, the fixing belt 31 slides smoothly with respect to the sliding member. In the present Embodiment, as the lubricant, silicone oil is used. Incidentally, the sliding member may be omitted.

The stay 32 is a member which supports the pressing pad 33 and heats the fixing belt 31 via the pressing pad 33, and is constituted by a hollow pipe (tubular member). In the present Embodiment, the stay 32 is constituted by a square pipe made of SUS (stainless steel) having a thickness of 3 mm. The stay 32 is supported by a frame (not shown) of the fixing device 30, etc. The stay 32 and the pressing pad 33 are contacting each other. Inside (in a hollow portion of) the stay 32, the heater inside the stay 36a constituted by a halogen heater as a heat source is disposed. The stay 32 is capable of generating heat up to a predetermined temperature. The fixing belt 31 is heated by the stay 32 via the pressing pad 33. Incidentally, in FIG. 2, one heater inside the stay 36a is shown, however, the heater inside the stay 36a may be two or more.

The heating roller 37 is a member which heats the fixing belt 31, and is constituted by a hollow pipe (tubular member). In the present Embodiment, the heating roller 37 is constituted by a pipe (circular pipe) made of aluminum material (aluminum or aluminum alloy) having a thickness of 2 mm. The heating roller 37 is rotatably supported by the frame (not shown) of the fixing device 30, etc. The rotational axis direction of the heating roller 37 is approximately parallel to the rotational axis direction of the photosensitive drum 11. Inside (in a hollow portion of) the heating roller 37, the heater inside the heating roller 36b constituted by a halogen heater as a heat source is disposed. The heating roller 37 is capable of generating heat up to a predetermined temperature. The fixing belt 31 is heated by the heating roller 37. Incidentally, in FIG. 2, one heater inside the heating roller 36b is shown, however, the heater inside the heating roller 36b may be two or more.

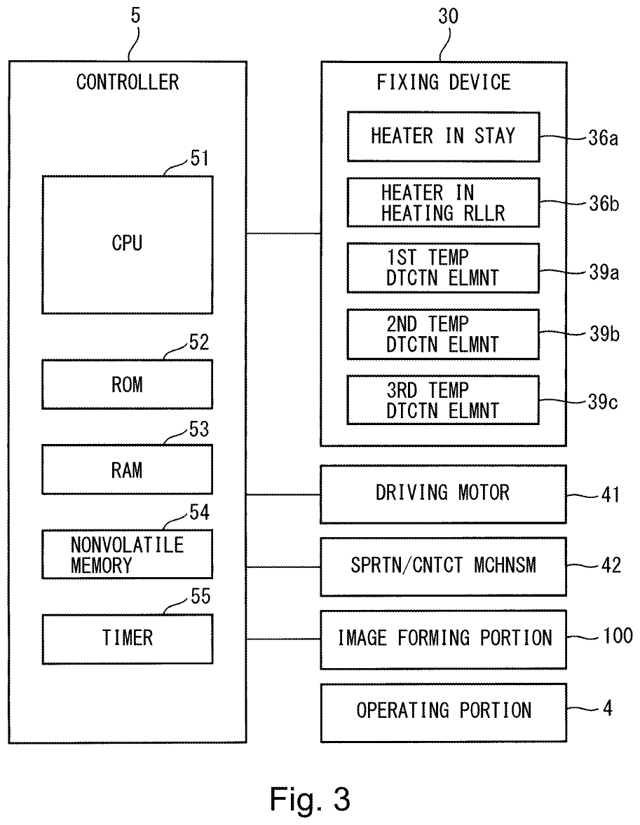

The pressing roller 35 is a roller including a core metal layer (rotation shaft), an elastic layer formed on an outer periphery of the core metal layer, and a releasing layer formed on an outer periphery of the elastic layer. In the present Embodiment, the core metal layer is formed of a tubular member made of SUS (stainless steel) having a diameter of 44 mm. In addition, in the present Embodiment, the elastic layer has a thickness of 8 mm, and electroconductive silicone rubber is used as material thereof. In addition, in the present Embodiment, the releasing layer has a thickness of 100 μm, and PFA (tetrafluoroethylene perfluoroalkoxyethylene copolymerization resin), which is fluororesin, is used as material thereof. The pressing roller 35 is rotatably and pivotally supported by a pressing arm (not shown) as a moving member movably provided to the frame (not shown) of the fixing device 30, etc. The rotational axis direction of the pressing roller 35 is approximately parallel to the rotational axis direction of the photosensitive drum 11 and the rotational axis direction of the heating roller 37. In the pressing roller 35, a gear is fixed to one end portion in the rotational axis direction thereof, and the pressing roller 35 is connected to a driving motor 41 (FIG. 3) as a driving source via the gear. And the pressing roller 35 is rotationally driven, by driving force transmitted from the driving motor 41, in a direction of an arrow R3 (counterclockwise direction) in FIG. 2. The pressing roller 35 forms, by contacting the pressing pad 33 via the fixing belt 31, the fixing nip portion (fixing portion) N together with the fixing belt 31. The fixing belt 31 is rotated (circulated), by being nipped between the pressing roller 35 and the pressing pad 33, in a direction of an arrow R4 (clockwise direction) in FIG. 2, driven by the rotation of the pressing roller 35. In addition, the pressing arm described above constitutes a contact/separation mechanism 42 (FIG. 2) as a contacting and separating means. The pressing arm described above is configured to be movable so as to cause the pressing roller 35 to be contacted to or be separated from the fixing belt 31 (be in contact with or separated from the pressing pad 33).

The first, the second, and the third temperature detecting elements 39a, 39b, and 39c are disposed so as to contact members to be detected, respectively. Specifically, the first temperature detecting element (stay temperature sensor) 39a is disposed so as to contact a surface (outside surface) of the stay 32, and is used to detect a surface temperature of the stay 32. In addition, the second temperature detecting element (heating roller temperature sensor) 39b is disposed so as to contact a surface (outer peripheral surface) of the heating roller 37, and is used to detect a surface temperature of the heating roller 37. In addition, the third temperature detecting element (pressing roller temperature sensor) 39c is disposed so as to contact a surface (outer peripheral surface) of the pressing roller 35, and is used to detect a surface temperature of the pressing roller 35. The first, the second, and the third temperature detecting elements 39a, 39b, and 39c output signals (for example, voltage signals) corresponding to temperatures of the members to be detected to the control portion 5, respectively. The first, the second, and the third temperature detecting elements 39a, 39b, and 39c are configured to include, for example, a thermistor, a thermocouple, etc., respectively. Incidentally, at least one of the first, the second, and the third temperature detecting elements 39a, 39b, and 39c may be constituted by a plurality of temperature detecting elements disposed at a plurality of positions in the widthwise direction approximately perpendicular to a moving direction of the surface of the fixing belt 31. In addition, the temperature detecting means may be a temperature detecting means which detects a temperature without contacting a member to be detected.

The fixing device 30 heats, in the fixing nip portion N formed between the fixing belt 31 and the pressing roller 35, the toner image on the recording material P while nipping and conveying the recording material P bearing the toner image. In this manner, the fixing device 30 fixes, while nipping and conveying the recording material P, the toner image onto the recording material P. Therefore, for the fixing device 30, it is necessary to serve both of a function for applying the heat and the pressure and a function for conveying the recording material P. By the pressing roller 35 being rotationally driven by the driving motor 41 as the driving source, the fixing belt 31 is rotated driven by the rotation of the pressing roller 35. The pressing roller 35 is pressed against the pressing pad 33 via the fixing belt 31. In the present Embodiment, pressing force in the fixing nip portion N during fixing operation is set to 1600 N. In addition, in the present Embodiment, a width of the fixing nip portion N in the X direction (conveyance direction of the recording material P) during fixing operation is set to 20 mm, and a width of the fixing nip portion N in the Y direction (widthwise direction of the recording material P) during fixing operation is set to 350 mm.

The steering roller 38 is rotated (tilted), about a rotational axis positioned at one end portion side or in a vicinity of a center in the rotational axis direction thereof, so that a rotational axis direction of the steering roller 38 is inclined with respect to the rotational axis direction of the heating roller 37. By this, the steering roller 38 generates a difference in tension between the front side and the rear side of the fixing belt 31, and controls a position of the fixing belt 31 in the Y direction (widthwise direction of the recording material P). In the present Embodiment, the steering roller 38 is constituted by a hollow roller (shaft) made of SUS (stainless steel) having a diameter of 20 mm. Incidentally, in order to increase a gripping force against the fixing belt 31, a surface layer constituted by rubber material, etc. may be provided on a surface of the steering roller 38.

### <Control Configuration of the Image Forming Apparatus>

Next, a control configuration of the image forming apparatus 1 in the present Embodiment will be described. FIG. 3 is a block diagram illustrating an outline control configuration of the image forming apparatus 1 in the present Embodiment.

The image forming apparatus 1 includes the control portion 5 as a control means which comprehensively controls the image forming apparatus 1. The control portion 5 is configured to include a CPU 51 as an arithmetic process means (arithmetic process portion), a ROM 52, a RAM 53, and a non-volatile memory 54 as storage means (storage portions), a timer 55 as a time measuring means (time measuring portion), and an input/output circuit (not shown) as an input/output means (input/output portion). The CPU 51 performs the control of the image forming apparatus 1. In the ROM 52, a control program, an application program, etc., which are executed by the CPU 51, are stored. The RAM 53 functions as a working area for executing a process of the control program. The non-volatile memory 54 holds data such as various types of settings which are desired to be held even when power of the image forming apparatus 1 is turned off. The timer 55 is capable of generation of a periodic time interval for the control and measurement of an elapsed time between two points. To the control portion 5, an operating portion (UI) 4, which is provided to the image forming apparatus 1, is connected. The operating portion 4 is configured to include a display portion, which performs display of information to a user (an operator) through control by the control portion 5, and an input portion, which inputs information such as various types of settings to the control portion 5 based on an operation from the user. The operating portion 4 may be configured to include a touch panel, etc. having the function of the display portion and the function of the input portion. In this case, the operating portion 4 performs screen display to the user and reception of a touch input from the user.

In addition, to the control portion 5, various types of loads, sensors, etc. constituting the fixing device 30 are connected. In the present Embodiment, to the control portion 5, the heater inside the stay 36a (a power supplying portion to the heater inside the stay 36a), the heater inside the heating roller 36b (a power supplying portion to the heater inside the heating roller 36b), and the first, the second, and the third temperature detecting elements 39a, 39b, and 39c are connected. Operations of the respective heaters 36a and 36b and the respective temperature detecting elements 39a, 39b, and 39c are controlled based on control signals from the control portion 5, respectively. In addition, to the control portion 5, the driving motor 41 and the contact/separation mechanism 42 are connected. Operations of the driving motor 41 and the contact/separation mechanism 42 are controlled based on control signals from the control portion 5, respectively.

Based on the received print information, by controlling an operation of each portion of the image forming apparatus 1 such as the image forming portion 100, the fixing device 30, the driving motor 41, and the contacting and separating mechanism 4, the control portion 5 controls the image forming apparatus 1 so as to execute a job. The print information includes a start instruction for a print, various types of settings on the print (for example, a type of the recording material P, a number of copies to be printed), etc. The job is a series of operations which is started by one start instruction and in which an image is formed and output on a single or a plurality of the recording material P. The user may input the information on the various types of settings such as the type of the recording material P used in the job and the number of copies to be printed to the control portion 5 from the operating portion 4 (or the external host device). And the control portion 5 executes, based on the various types of settings input by the user, an operation for the job including the image formation based on the image signal and the fixing operation in the fixing device 30, etc.

Incidentally, the control portion 5, which controls each portion of the fixing device 30, may also be regarded as a portion constituting the fixing device 30.

### <Temperature Rising Speeds of the Heating Members and the Fixing Member>

First, temperature rising speeds of the heating members will be described. The pad portion 34 and the heating roller 37 constitute the heating members for heating the fixing belt 31, respectively. In other words, the stay 32 is the supporting member (a structural member), which supports the pressing pad 33, and is the heating member which heats the fixing belt 31 via the pressing pad 33. Here, heating of the fixing belt 31 by the pad portion 34 may be described as heating of the fixing belt 31 by the stay 32. Inside the stay 32 and the heating roller 37, the heater inside the stay 36a and the heater inside the heating roller 36b as heating sources are disposed, respectively. The temperature rising speed of the heating member is determined by, for example, a heat capacity of a member being used and an amount of heat applied from a heating source. Specifically, the larger the heat capacity of the heating member is, the slower the temperature rising speed becomes, and the larger a heating amount of the heating source is, the faster the temperature rising speed becomes.

Next, the temperature rising speed of the fixing member will be described.

The temperature rising speed of the fixing belt 31 as the fixing member is determined by, for example, the temperature rising speed of the heating member, thermal physical properties including a thermal conductivity of the heating member, etc., and a contact state between the fixing belt 31 and the heating member. Specifically, the temperature rising speed of the fixing belt 31 by the stay 32 is determined by a heat capacity of the stay 32, a heating amount of the heater inside the stay 36a, a thermal physical property and a thermal conduction characteristic of the pressing pad 33 disposed between the fixing belt 31 and the stay 32, a thermal physical property of the sliding member disposed between the pressing pad 33 and the fixing belt 31, and thermal resistances and contact areas between the respective members of the fixing belt 31, the sliding member, the pressing pad 33, and the stay 32. In addition, the temperature rising speed of the fixing belt 31 by the heating roller 37 is determined by a heat capacity of the heating roller 37, a heating amount of the heater inside the heating roller 36b, and a thermal resistance and a contact area between the fixing belt 31 and the heating roller 37.

In the present Embodiment, the stay 32 and the heating roller 37 are designed so as to have heat capacities shown in Table 1, respectively. In other words, in the present Embodiment, the heat capacity of the stay 32 is larger than the heat capacity of the heating roller 37. Therefore, in the present Embodiment, the heat capacity of the pad portion 34 is larger than the heat capacity of the heating roller 37. In addition, in the present Embodiment, the heater inside the stay 36a is designed so as the heating amount (a maximum heating amount) thereof to be 300 W, and the heater inside the heating roller 36b is designed so as the heating amount (a maximum heating amount) thereof to be 1400 W. In other words, in the present Embodiment, the heating amount (maximum heating amount) of the heater inside the heating roller 36b is larger than the heating amount (maximum heating amount) of the heater inside the stay 36a.

Therefore, the temperature rising speed of the heating roller 37 is faster than the temperature rising speed of the stay 32.

In addition, the heating roller 37 contacts the fixing belt 31 in a range of 60 mm in a peripheral direction of the heating roller 37. In addition, the stay 32 contacts, via the pressing pad 33, the fixing belt 31 in a range of 20 mm in the conveyance direction of the recording material P. Further, the pressing pad 33 is constituted by using LCP, as the material thereof, having a thickness of about 3 mm and a thermal conductivity of about 0.38 W/m K. Therefore, the temperature rising speed of the fixing belt 31 by the heating roller 37 in a case in which the heater inside the heating roller 36b generates the heat with the maximum heating amount is faster than the temperature rising speed of the fixing belt 31 by the stay 32 in a case in which the heater inside the stay 36a generates the heat with the maximum heating amount. This is because by the pressing pad 33 having a thermal conductivity smaller than that of the stay 32 being sandwiched as a heat insulating member between the fixing belt 31 and the stay 32, it is suppressed that heat of the fixing belt 31 is taken by the stay 32, which has the large heat capacity, at the fixing nip portion N. In the present Embodiment, in the case in which the heater inside the heating roller 36b generates the heat with the maximum heating amount, the temperature rising speed of the fixing belt 31 by the heating roller 37 is approximately 2 °C/s. In addition, in the present Embodiment, in the case in which the heater inside the stay 36a generates the heat with the maximum heating amount, the temperature rising speed of the fixing belt 31 by the stay 32 (in other words, the pad portion 34) is approximately 0.05 °C/s. In other words, in the present Embodiment, the temperature rising speed of the fixing belt 31 by the heating roller 37 in the case in which the heater inside the heating roller 36b generates the heat with the maximum heating amount is faster than the temperature rising speed of the fixing belt 31 by the stay 32 (in other words, the pad portion 34) in the case in which the heater inside the stay 36a generates the heat with the maximum heating amount.

TABLE 1

| | | Specific | | | Heat |
|---|---|---|---|---|---|
| MEMBER | MATERIAL | heat | Density | Volume | capacity |
| NAME | NAME | [J/g K] | [g/cm³] | [mm³] | [J/K] |
| HEATING | Aluminum | 0.94 | 2.7 | 130000 | 330 |
| ROLLER | | | | | |
| STAY | Stainless | 0.5 | 7.93 | 109000 | 432 |

Here, from a viewpoint of control, an outline of a role of each heating member will be described. The heating roller 37 has, as a main heating member for heating the fixing belt 31, a role of adjusting a temperature of the fixing belt 31 sequentially. On the other hand, the stay 32 has, as an auxiliary heating member for heating the fixing belt 31, in a case in which it is necessary, a role of assisting to keep the temperature of the fixing belt 31 by raising temperatures of the members inside (in an area surrounded by an inner peripheral surface of) the fixing belt 31 entirely. The case in which it is necessary is, for example, during continuous printing using the recording material P (thick paper, etc.), to which it is required to apply a relatively large amount of the heat, etc., a case in which temperature rising performance of the fixing belt 31 is insufficient only with the heating roller 37. Therefore, during continuous printing using the recording material P (plain paper, thin paper, etc.), to which it is not required to apply the relatively large amount of the heat, or in a case in which a number of prints is small, etc., there is a case in which it is sufficient only with the temperature rising ability of the fixing belt 31 by the heating roller 37, and the auxiliary temperature rising ability of the fixing belt 31 by the stay 32 is not necessary.

### <Classification of States of the Fixing Device>

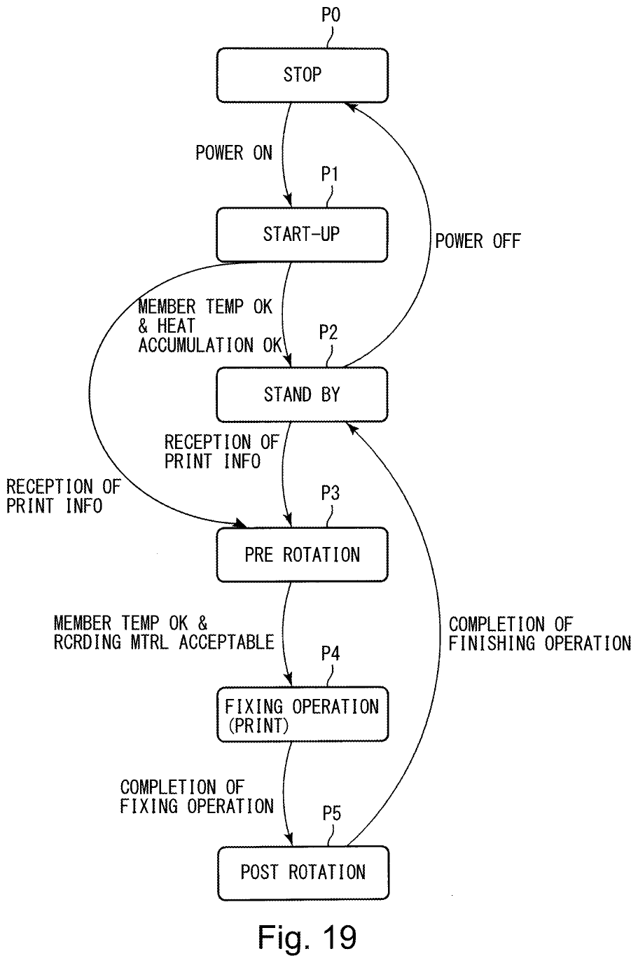

States of the fixing device 30 in the present Embodiment will be described. As shown in FIG. 19, the states of the fixing device 30 in the present Embodiment may be classified, when roughly divided, into six states of a stop P0, a start-up P1, a standby P2, a pre rotation P3, a fixing operation P4, and a post rotation P5. FIG. 19 is a schematic view illustrating a flow of how each of these states shifts.

With reference to FIG. 19, each state will be briefly described. Here, an outline of each state is described, and details of a start-up control depending on a heat storage (accumulation) state of the fixing device 30, which is characteristic in the present Embodiment, will be described below.

The stop P0 is a state, such as a situation in which the power of the image forming apparatus 1 is turned off, in which the fixing device 30 is completely stopped (rotational drive and energization to the heating sources are stopped). Incidentally, the stop P0 includes, in addition to a state in which energization to all elements of the image forming apparatus 1 is stopped, a state in which energization to some elements such as the control portion 5 is possible but the fixing device 30 is completely stopped (a sleep state of the image forming apparatus 1).

The start-up P1 is a state from a timing when the power of the image forming apparatus 1 is turned on (ON) (or the sleep state of the image forming apparatus 1 is released), until the temperature of each member of the fixing device 30 such as the heating roller 37 toward a target temperature thereof is adjusted, through the heat accumulation process, and the fixing device 30 shifts to the standby P2. In addition, the start-up P1 is a state, in a case in which the control portion 5 receives the print information during the start-up P1, until the fixing device 30 shifts to the pre rotation P3 without going through the standby P2.

The standby P2 is a state in which the fixing device 30 may shift to the pre rotation P3, which is preparation for the fixing operation (preparation for printing) at any time upon the temperature of each member of the fixing device 30 such as the heating roller 37 reaching the target temperature and the print information being input to the control portion 5.

The pre rotation P3 is a state, from the standby P2 (or the start-up P1) until the print information is input to the control portion 5 and the fixing device 30 prepares for receiving the recording material P for the fixing operation P4. More specifically, in the present Embodiment, in the pre rotation P3, an operation to cause the pressing roller 35 to be in contact with the fixing belt 31 is performed. In addition, in the pre rotation P3, an operation to change the target temperature of the heating roller 37 and an operation to change a process speed may be performed. The target temperature (fixing temperature) of the heating roller 37 is, for example, set in advance corresponding to the type (paper type) of the recording material P, and is stored in the ROM 52. In addition, the process speed is, for example, set in advance corresponding to the type (paper type) of the recording material P, and is stored in the ROM 52. The process speed is equivalent to a peripheral speed (moving speed of the surface) of the fixing belt 31. The control portion 5 may set, for each job, based on the information on the type of the recording material P included in the acquired print information, the target temperature of the heating roller 37 and the process speed to the fixing device 30.

The fixing operation P4 is a state in which the fixing device 30 is receiving the recording material P, applying the heat and the pressure to the toner image on the recording material P, and fixing the toner image onto the recording material P. Here, the fixing operation P4 includes states of the fixing device 30 in a standby period which may occur due to preparation in the image forming portion 100, etc. despite the fixing device 30 is ready to receive the recording material P, and in a period between a preceding recording material P and a succeeding recording material P (sheet interval) which occurs upon conveying a plurality of the recording material P. Since the fixing operation P4 may be regarded as a printing operation in the fixing device 30, the “fixing operation P4” may also be referred to as a “printing P4”.

The post rotation P5 is a state in which after the fixing operation P4 is completed and all the recording materials P in the job have passed through the fixing device 30, preparation for causing the fixing device 30 to return to the standby P2 again is performed. More specifically, in the present Embodiment, in the post rotation P5, an operation to cause the pressing roller 35 to be separated from the fixing belt 31 is performed. In addition, in the post rotation P5, in order to cause the fixing device 30 to return to the standby P2, an operation to return the target temperature of the heating roller 37 and the process speed to initial values (default values) thereof may be performed.

In addition, from the standby P2, when the power of the image forming apparatus 1 is turned off, the fixing device 30 shifts to the stop P0. Alternatively, it may be configured that, in the standby P2, if a predetermined condition such as a predetermined time elapses is satisfied, the fixing device 30 shifts to the stop P0.

Incidentally, in the present Embodiment, the rotation of the pressing roller 35 is started at a time of start of the start-up P1, the rotation of the pressing roller 35 is continued in the standby P2, the pre rotation P3, and the fixing operation P4, and the rotation of the pressing roller 35 is stopped in the post rotation P5. However, for example, the rotation of the pressing roller 35 may be stopped in at least a part of the periods in the start-up P1 and the standby P2, respectively.

In addition, in the present Embodiment, during the stop P0 and the standby P2, the pressing roller 35 is caused to be separated from the fixing belt 31. And as described above, the pressing roller 35 is caused to be in contact with the fixing belt 31 during the pre rotation P3, is kept in contact with the fixing belt 31 during the fixing operation P4, and is caused to be separated from the fixing belt 31 during the post rotation P5. However, as it will be described below, it is also possible to cause the pressing roller 35 to be in contact with the fixing belt 31 for at least a part of a period during the start-up P1.

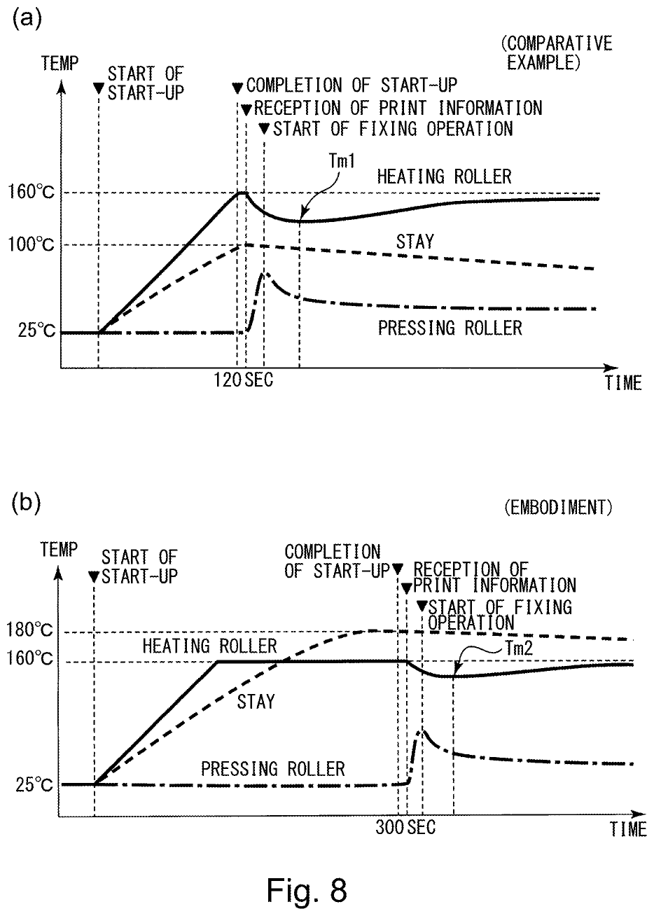

For example, in a temperature transition of each member of the fixing device 30 shown in part (b) of FIG. 8 in a control which will be described below, a period from the “start of the start-up” to a “completion of the start-up” corresponds to a period of the start-up P1. In addition, a period from “receiving of the print information” to a “start of the fixing operation” corresponds to a period of the pre rotation P3. In addition, a period after the “start of the fixing operation” corresponds to a period of the “fixing operation P4”. In addition, for example, in part (b) of FIG. 8, an example in which the state substantially shifts from the start-up PI to the pre rotation P3 without passing through the standby P2 is shown, however, a period from the “completion of the start-up” to the “receiving of the print information” corresponds to the standby P2.

### <Determination of the Heat Storage State During Start-Up of the Fixing Device Based on the Temperature of the Stay>

Next, an advantage of using the temperature of the stay 32, in other words, the temperature detected by the first temperature detecting element 39a as a heat storage (accumulation) index temperature during start-up (activation) of the fixing device 30 will be described.

In the present Embodiment, the heat capacity of the stay 32 is larger than the heat capacity of the heating roller 37. In particular, in the present Embodiment, the stay 32 is a member having a largest heat capacity among members which are present inside (in the area surrounded by the inner peripheral surface of) the fixing belt 31. Therefore, a fact that the temperature of the stay 32 is relatively low means that a heat storage amount of the members inside the fixing belt 31 is relatively small. Here, the temperature transition of each member during start-up of the fixing device 30 is considered. In the present Embodiment, since the temperature rising speed of the heating roller 37 is faster than the temperature rising speed of the stay 32, during start-up of the fixing device 30, the temperature of the heating roller 37 reaches the target temperature thereof before the temperature of the stay 32 reaches the target temperature thereof.

Assuming a case in which the temperature (an initial temperature) of the heating roller 37 at the start of the start-up of the fixing device 30 is detected by the second temperature detecting element 39b, and a control to determine the heat storage state during start-up of the fixing device 30 using the detected temperature as the heat storage index temperature during start-up of the fixing device 30 is performed. In this case, even in a situation in which a heat storage of the fixing device 30 is insufficient, there is a possibility that it is erroneously determined that the heat storage is sufficient. The situation in which the heat storage of the fixing device 30 may become insufficient is, for example, a case in which the fixing device 30 is stopped in a situation in which the heating roller 37 has reached the target temperature thereof but the stay 32 has not reached the target temperature thereof, and the fixing device 30 is started up again, etc. Specifically, it is a case in which the fixing device 30 is started up again after a jam clearance, etc. In this manner, for example, there is a case in which the power of the image forming apparatus 1 is turned off and on in the state in which the heating roller 37 has reached the target temperature thereof (fixing temperature, adjusting temperature) but the heat storage of the stay 32 is insufficient. In such a case, by determination that the heat storage is sufficient even though the heat storage is actually insufficient being made, there is a possibility that fixing performance may decrease during fixing operation.

To the contrary, in the present Embodiment, the temperature (an initial temperature) of the stay 32 at the start of the start-up of the fixing device 30 is detected by the first temperature detecting element 39a, and a control to determine the heat storage state during start-up of the fixing device 30 using the detected temperature as the heat storage index temperature during start-up of the fixing device 30 is performed. In this case, in the situation in which the heat storage of the fixing device 30 is insufficient as described above, since it is the situation in which the heating roller 37 has reached the target temperature thereof but the stay 32 has not reached the target temperature thereof, it becomes possible to correctly determine the heat storage state.

In the present Embodiment, the temperature of the stay 32 detected by the first temperature detecting element 39a at the start of the start-up of the fixing device 30 may be simply referred to as the “heat storage index temperature”.

Incidentally, a timing for acquiring the heat storage index temperature at the start of the start-up of the fixing device 30 is, typically, a timing before the heat generations of the heater inside the stay 36a and the heater inside the heating roller 36b are started. However, as long as it is possible to acquire the heat storage index temperature in a state in which a temperature rise of the stay 32 along the start-up of the fixing device 30 is sufficiently small, it may be a timing after the heat generation of at least one of the heater inside the stay 36a and the heater inside the heating roller 36b is started.

In addition, in the present Embodiment, the heat storage state of the fixing device 30 is determined by using the temperature of the stay 32 as the heat storage index temperature, however, the heat storage state of the fixing device 30 may be determined by using both the temperature of the stay 32 and the temperature of the heating roller 37.

### <Selection of the Start-Up Control of the Fixing Device Depending on the Heat Storage State>

Next, the start-up control of the fixing device 30 depending on the heat storage state (heat storage index temperature) of the fixing device 30 will be described.

### {Control of a Heat Storing Time (Start-Up Time)}

In the situation in which the heat storage of the stay 32 is insufficient, as a means for promoting the heat storage during start-up of the fixing device 30, it is effective, by delaying the shift to the state in which the fixing operation can be started, to secure a time (heat storing time) for heat to be moved to the stay 32. In addition, the same applies to a period from the standby state upon receiving the print information until the fixing operation is started. As a means for promoting the heat storage from the sleep state or the standby state until the fixing operation is started, it is effective, by extending a time from receiving the print information until the fixing device 30 becomes ready to receive the recording material P, to secure the heat storing time. In this manner, by securing the heat storing time, by the time which allows the temperature even of the stay 32, of which the temperature rising speed is slow, to be raised being given, it becomes possible to achieve a required heat storage state.

Therefore, based on the heat storage index temperature, a control to change the time (here, also referred to as “heat storing time”) from the start to the completion of the start-up of the fixing device 30 may be performed. In other words, it is possible, based on the heat storage index temperature, to perform a control to change the time from the start of the start-up of the fixing device 30 until it is determined that the fixing operation can be started. For example, it may be configured that the lower the heat storage index temperature is, the longer the heat storing time is set to.

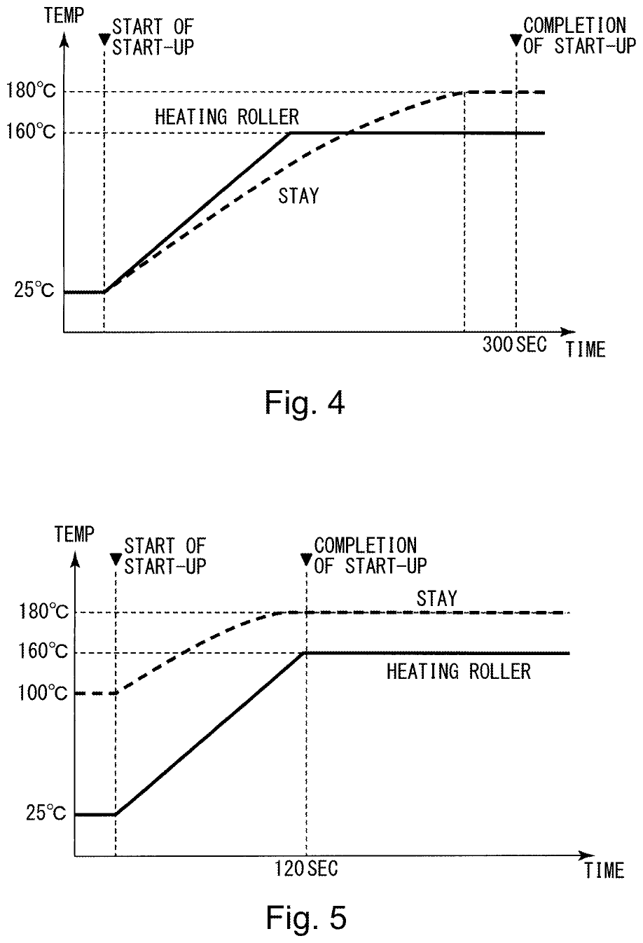

FIG. 4 is a graph view showing an example of the temperature transition of each member from the start to the completion of the start-up upon starting up the fixing device 30 from a state in which the temperature of the stay 32 is the same as an environmental temperature (for example, 25 °C). In addition, FIG. 5 is a graph view showing an example of the temperature transition of each member from the start to the completion of the start-up upon starting up the fixing device 30 from a state in which the temperature of the stay 32 is high to some degree (for example, 100 °C). In this example, the target temperature of the heating roller 37 is 160 °C. The control portion 5 performs, so that the temperature of the heating roller 37 becomes the target temperature thereof, a control of power supply (ON/OFF control, etc.) to the heater inside the heating roller 36b. In addition, in this example, the target temperature of the stay 32 is 180 °C. The control portion 5 performs, so that the temperature of the stay 32 becomes the target temperature thereof, a control of power supply (ON/OFF control, etc.) to the heater inside the stay 36a. In this example, the target temperature of the stay 32 during start-up is higher than the target temperature of the heating roller 37 during start-up (and during fixing operation). As shown in FIG. 4, upon starting up the fixing device 30 from the state in which the temperature of the stay 32 is relatively low, the heat storing time is configured to be relatively long. On the other hand, as shown in FIG. 5, upon starting up the fixing device 30 from the state in which the temperature of the stay 32 is relatively high, the heat storing time is configured to be relatively short.

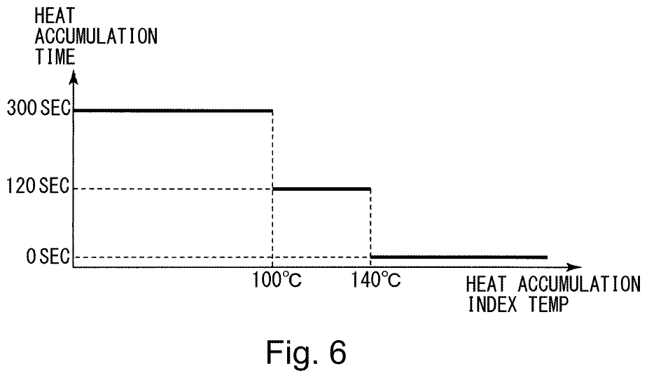

FIG. 6 is a graph view showing an example of a setting of the heat storing time depending on the heat storage index temperature. In the present Embodiment, according to a relationship as shown in FIG. 6, the heat storing time is changed stepwise depending on the heat storage index temperature. In other words, in the present Embodiment, the heat storing time is set to 300 seconds if the heat storage index temperature is less than 100 °C, to 120 seconds if the heat storage index temperature is 100 °C or higher and lower than 140 °C, and to 0 seconds if the heat storage index temperature is 140 °C or higher.

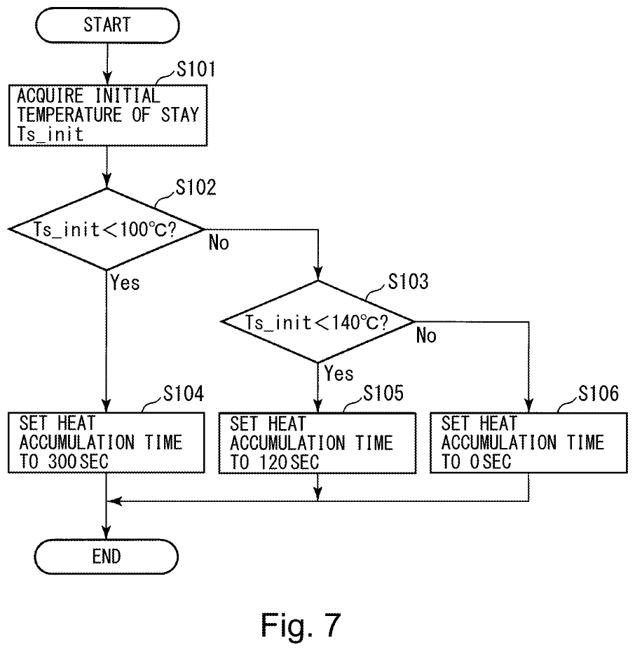

FIG. 7 is a flowchart diagram showing an outline of an example of the control to change the heat storing time. First, upon starting the start-up of the fixing device 30, the control portion 5 acquires a detection result of an initial temperature Ts_init of the stay 32 by the first temperature detecting element 39a (S101). This initial temperature Ts_init of the stay 32 is used as the heat storage index temperature. Next, the control portion 5 determines whether or not the initial temperature Ts_init of the stay 32 is lower than 100 °C (S102).

If the control portion 5 determines that the initial temperature Ts_init of the stay 32 is lower than 100 °C in S102, then the control portion 5 controls so as to set the heat storing time to 300 seconds (S104). If the control portion 5 determines that the temperature is not less than 100 °C (i.e., 100 °C or higher), then the control portion 5 determines whether or not the initial temperature Ts_init of the stay 32 is lower than 140 °C (i.e., whether or not the initial temperature Ts_init of the stay 32 is 100 °C or higher and lower than 140 °C) (S103). If the control portion 5 determines that the initial temperature Ts_init of the stay 32 is lower than 140 °C in S103, then the control portion 5 controls so as to set the heat storing time to 120 seconds (S105). If the control portion 5 determines that the initial temperature Ts_init of the stay 32 is not lower than 140 °C (i.e., 140 °C or higher) in S103, the control portion 5 controls so as to set the heat storing time to 0 seconds (S106).

Part (a) of FIG. 8 is a graph view showing an example of the temperature transition of each member in a case in which continuous printing (continuous sheet passing) is performed, as a Comparative Example, by starting the fixing operation in a state in which the heat storage of the stay 32 is insufficient. Part (b) of FIG. 8 is a graph view showing an example of the temperature transition of each member in a case in which the continuous printing is performed, according to the present Embodiment, by starting the fixing operation after securing a necessary heat storing time for sufficiently allowing the stay 32 to store heat. The fixing device 30 in the present Embodiment has a configuration in which the temperature of the fixing belt 31 decreases to a lowest thereof in several seconds at an initial stage of the start of the fixing operation, and thereafter, the temperature of the fixing belt 31 gradually recovers. Here, the lowest temperature of the heating roller 37 upon the temperature of the heating roller 37 decreasing from the target temperature as the fixing operation is started is referred to as a “lowest point temperature”. As shown in part (a) of FIG. 8, the lowest point temperature in the case in which the fixing operation is started in the state in which the heat storage of the stay 32 is insufficient is Tm1. On the other hand, as shown in part (b) of FIG. 8, by securing the necessary heat storing time for sufficiently allowing the stay 32 to store heat according to the present Embodiment, the lowest point temperature became Tm2 (>Tm1), and Tm2 is improved by approximately 2 °C with respect to Tm1.

Incidentally, the setting of the heat storing time with respect to the heat storage index temperature is not limited to the three stages, but may be two stages, or four stages or more.

In addition, the heat storing time may be changed continuously (linearly or curvilinearly) depending on the heat storage index temperature.

### {Control of the Target Temperature of the Heating Roller During Start-Up}

It is also possible to change, based on the heat storage index temperature, the target temperature of the heating roller 37 during start-up of the fixing device 30. In particular, it is more effective to control, based on the heat storage index temperature, in addition to controlling the heat storing time as described above, the target temperature of the heating roller 37 during start-up of the fixing device 30. However, it is possible to change, based on the heat storage index temperature, at least one of the heat storing time and the target temperature of the heating roller 37 during start-up.

For example, it may be configured that the lower the heat storage index temperature is, the higher the target temperature of the heating roller 37 during start-up is set to. In addition, for example, it may be configured that the target temperature of the heating roller 37 during start-up to be higher than the target temperature of the stay 32 during start-up (and the target temperature of the heating roller 37 during fixing operation). In this manner, by resetting the target temperature of the heating roller 37 during start-up of the fixing device 30 to be higher, a temperature difference between the members is increased, and it becomes possible to increase an amount of heat moved from the heating roller 37 to the stay 32 via the fixing belt 31 and the fixing pad 33. In addition, it becomes possible to promote heating through radiation from the heating roller 37 to the stay 32.

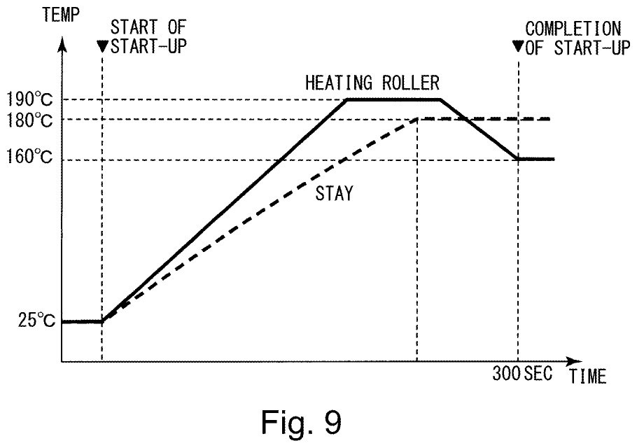

FIG. 9 is a graph view showing an example of the temperature transition of each member from the start to the completion of the start-up upon starting up the fixing device 30 from a state in which the temperature of the stay 32 is the same as the environmental temperature (for example, 25 °C). In this example, the target temperature of the heating roller 37 during fixing operation is 160 °C. In addition, in this example, the target temperature of the stay 32 is 180 °C. In addition, in this example, according to the control of the heat storing time depending on the heat storage index temperature described above, the heat storing time is set to 300 seconds. And in this example, in at least a part of a period during start-up, the target temperature of the heating roller 37 is set to 190 °C, which is higher than the target temperature of the stay 32 during start-up (and the target temperature of the heating roller 37 during fixing operation). Incidentally, the target temperature of the heating roller 37 during start-up may be set, for example, to 190 °C if the heat storage index temperature is lower than 100 °C, to 180 °C if the heat storage index temperature is 100 °C or higher and lower than 140 °C, and to 160 °C, which is the same as the target temperature during fixing operation, if the heat storage index temperature is 140 °C or higher.

Incidentally, the target temperature of the heating roller 37 during start-up may be returned to the target temperature of the heating roller 37 during fixing operation after maintaining the state of setting the target temperature higher as described above for a predetermined time or if the temperature of the stay 32 reaches the target temperature. For example, the heat storing time, a period for which the target temperature of the heating roller 37 is set to be higher, etc. may be set so that the start-up is completed after the temperature of the stay 32 reaches the target temperature and the temperature of the heating roller 37 returns to the target temperature during fixing operation.

In addition, the setting of the target temperature of the heating roller 37 during start-up depending on the heat storage index temperature is not limited to the three stages, but may be two stages, or four stages or more.

In addition, the target temperature of the heating roller during start-up may be changed continuously (linearly or curvilinearly) depending on the heat storage index temperature.

### {Heat Storage Control of the Pressing Roller}

During start-up of the fixing device 30, it is also possible, in addition to the members inside (in the area surrounded by the inner peripheral surface of) the fixing belt 31, to promote heat storage of the pressing roller 35, which is in contact with the fixing belt 31 from the outer peripheral surface side of the fixing belt 31.

For example, under the condition in which the heat storage of the stay 32 is insufficient, it is possible to control so as to bring the pressing roller 35 into contact with the fixing belt 31 during start-up of the fixing device 30, and to allow heat to be moved from the heating roller 37 to the pressing roller 35 via the fixing belt 31. A period during which the pressing roller 35 is brought into contact with the fixing belt 31 during start-up of the fixing device 30, or whether or not to the pressing roller 35 is brought into contact therewith may be changed depending on the heat storing time (i.e., the heat storage index temperature). For example, a time for which the pressing roller 35 is brought into contact with the fixing belt 31 during start-up of the fixing device 30 may be configured to be longer as the heat storing time is longer (i.e., as the heat storage index temperature is lower).

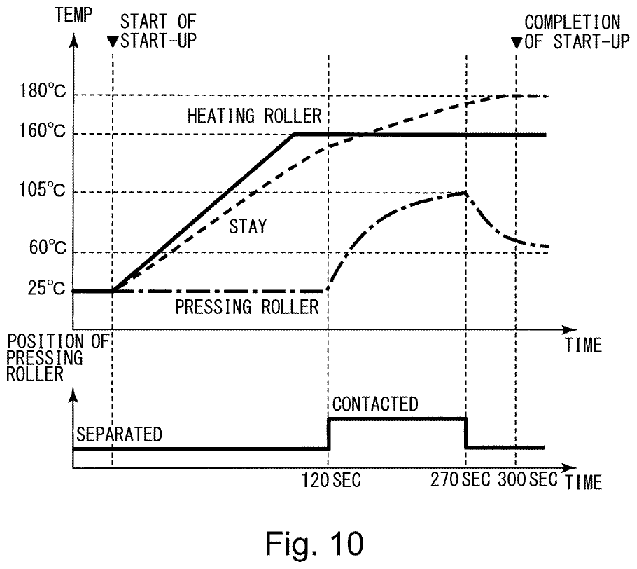

FIG. 10 is a graph view showing an example of the temperature transition of each member and a shift of a contact/separation state of the pressing roller 35 with respect to the fixing belt 31 from the start to the completion of the start-up upon starting up the fixing device 30 from the state in which the temperature of the stay 32 is the same as the environmental temperature (for example, 25 °C). In this example, the target temperature of the heating roller 37 is 160 °C. In addition, in this example, the target temperature of the stay 32 is 180 °C. In addition, in this example, according to the control of the heat storing time depending on the heat storage index temperature described above, the heat storing time is set to 300 seconds. And in this example, for 150 seconds between 120 seconds after the start of start-up and 270 seconds after the start of start-up, which is at least a part of a period during start-up, the pressing roller 35 is brought into contact with the fixing belt 31. Incidentally, the time for which the pressing roller 35 is brought into contact with the fixing belt 31 during start-up of the fixing device 30 may be set, for example, to 150 seconds if the heat storage index temperature is lower than 100 °C, to 60 seconds if the heat storage index temperature is 100 °C or higher and lower than 140 °C, and 0 seconds (i.e., the pressing roller 35 is not brought into contact therewith) if the heat storage index temperature is 140 °C or higher.

Incidentally, the setting of the time, for which the pressing roller 35 is brought into contact with the fixing belt 31 depending on the heat storage index temperature, is not limited to the three stages, but may be two stages, or four stages or more.

In addition, the time for which the pressing roller 35 is brought into contact with the fixing belt 31 may be changed continuously (linearly or curvilinearly) depending on the heat storage index temperature.

In addition, from a viewpoint of efficiently allowing heat to be moved from the heating roller 37 to the pressing roller 35, etc., it is preferable to bring the pressing roller 35 into contact with the fixing belt 31 after the temperature of the heating roller 37 reaches the target temperature thereof during start-up.

By bringing the pressing roller 35 into contact with the fixing belt 31 during start-up of the fixing device 30 in this manner, upon the completion of the start-up of the fixing device 30, for example, it becomes possible to raise the temperature of the pressing roller 35 to approximately 60 °C (allow the pressing roller 35 to store heat). Therefore, upon the fixing belt 31 being in contact with the pressing roller 35 upon a first fixing operation in a job (upon a fixing operation for a first recording material P in the job), it becomes possible to suppress heat from being taken from the fixing belt 31 to the pressing roller 35.

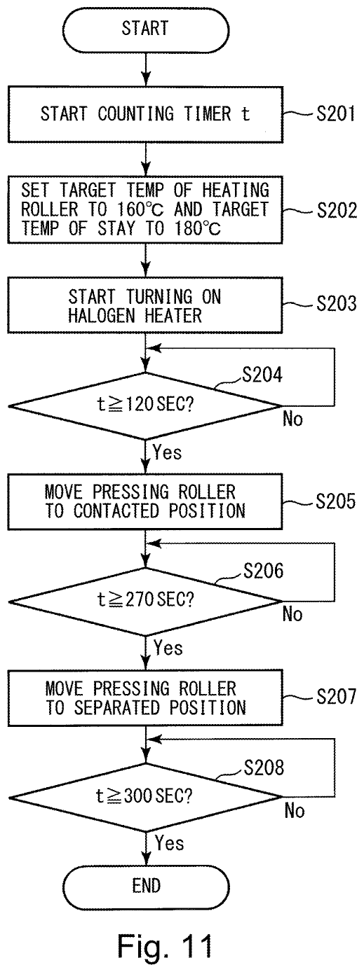

FIG. 11 is a flowchart diagram showing an outline of an example of the control to bring the pressing roller 35 into contact with the fixing belt 31 during start-up of the fixing device 30. Here, a case in which, upon starting the start-up of the fixing device 30, the heat storing time is set to 300 seconds according to the control described using FIG. 7 is exemplified. First, upon starting the start-up of the fixing device 30, the control portion 5 sets the heat storing time (here, to 300 seconds) and starts counting of a timer t (the timer 55 in FIG. 3) (S201). Next, the control portion 5 sets the target temperature of the heating roller 37 to 160 °C and the target temperature of the stay 32 to 180 °C (S202), and starts the heat generations (lightings) of the heater inside the heating roller 36b and the heater inside the stay 36a (S203). Thereafter, the control portion 5 waits for the counting of the timer t to reach 120 seconds (S204), and when reached, the control portion 5 controls so as to cause the pressing roller 35 to be moved to a position to be in contact with the fixing belt 31 (contact position) with the contact/separation mechanism 42 (S205). Thereafter, the control portion 5 waits for the counting of the timer t to reach 270 seconds (S206), and when reached, the control portion 5 controls so as to cause the pressing roller 35 to be moved to a position to be separated from the fixing belt 31 (separated position) with the contact/separation mechanism 42 (S207). Thereafter, the control portion 5 waits for the counting of the timer t to reach 300 seconds (S208), and when reached, the control portion 5 completes the start-up of the fixing device 30.

Incidentally, in the present Embodiment, the timing of the contact and the separation of the pressing roller 35 with respect to the fixing belt 31 is managed by time, however, it is not limited thereto. For example, it may be configured that a threshold value may be set for at least one of the temperatures of the heating roller 37, the pressing roller 35, and the stay 32, and if the temperature reaches the threshold value, it is determined that it is the timing to bring the pressing roller 35 into contact with or separated from the fixing belt 31. In other words, the pressing roller 35 may be brought into contact with the fixing belt 31 for a predetermined time, which is at least a part of a period during start-up of the fixing device 30. In addition, the pressing roller 35 may be brought into contact with the fixing belt 31 so that the temperature of the pressing roller 35 upon the completion of start-up of the fixing device 30 becomes a predetermined temperature.

In addition, the control to bring the pressing roller 35 into contact with the fixing belt 31 during start-up of the fixing device 30 may be used in combination with the control to change the target temperature of the heating roller 37 during start-up described above.

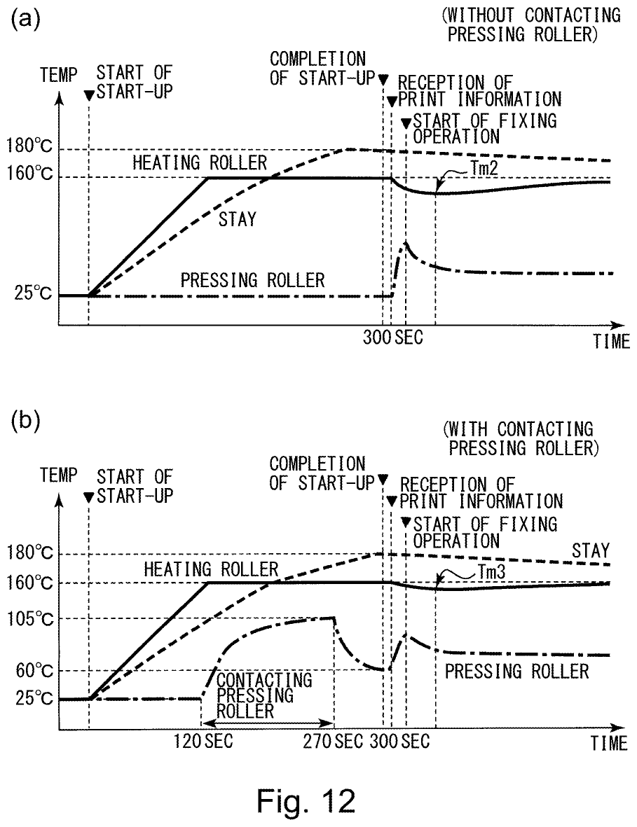

Part (a) of FIG. 12 is a graph view showing an example of the temperature transition of each member in a case in which the control of the heat storing time is performed according to the present Embodiment and the control to bring the pressing roller 35 into contact with the fixing belt 31 during start-up of the fixing device 30 is not performed (the same as the graph view shown in part (b) of FIG. 8). In addition, part (b) of FIG. 12 is a graph view showing an example of the temperature transition of each member in a case in which the control of the heat storing time is performed according to the present Embodiment and the control to bring the pressing roller 35 into contact with the fixing belt 31 during start-up of the fixing device 30 is performed. As shown in part (a) of FIG. 12, the lowest point temperature in the case in which the heat storage to the pressing roller 35 is not performed during start-up of the fixing device 30 is Tm2. On the other hand, as shown in part (b) of FIG. 12, in the case in which the heat storage to the pressing roller 35 is performed during start-up of the fixing device 30, the lowest point temperature became Tm3 (>Tm2), and Tm3 is improved by approximately 3 °C with respect to Tm2.

### {Control of a Fan}

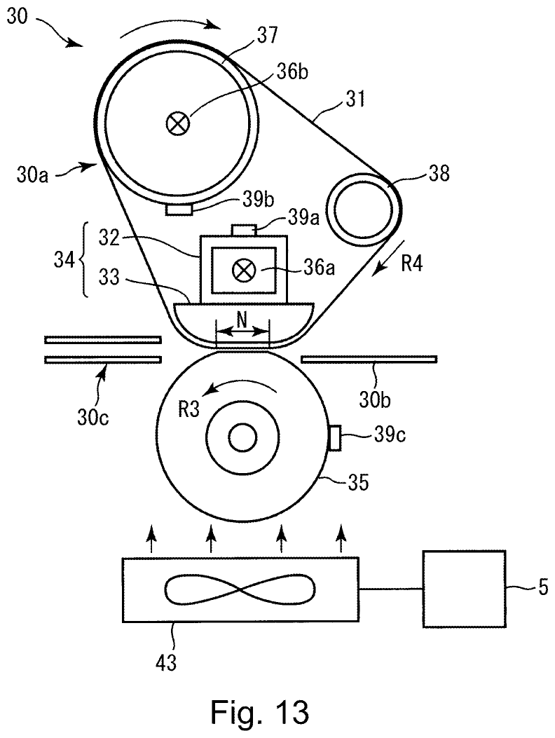

FIG. 13 is a schematic cross-sectional view of a vicinity of the fixing device 30. The fixing device 30 may include a cooling fan 43, which is an air blowing mechanism, as a cooling means for cooling the pressing roller 35. Based on a control signal from the control portion 5, an operation of the cooling fan 43 is controlled.

And during start-up of the fixing device 30, by causing the cooling fan 43 to be operated, which causes heat to be moved from the pressing roller 35 to a whole of the fixing device 30 outside the pressing roller 35 such as the fixing belt 31, it becomes also possible to promote heat storage as a whole of the fixing device 30. The whole of the fixing device 30 referred to here includes, in addition to the heating unit 30a and the pressing roller 35, guide members such as the entrance guide 30b and the separating guide 30c, etc. In a case in which the fixing device 30 includes a casing which accommodates the heating unit 30a, the pressing roller 35, etc., this casing may be included in the whole of the fixing device 30.

For example, in addition to bringing the pressing roller 35 into contact with the fixing belt 31 during start-up of the fixing device 30 as described above, the cooling fan 43 may be caused to be operated. Heat supplied from the heater inside the heating roller 36b is moved via the heating roller 37, the fixing belt 31, and the pressing roller 35. Furthermore, by wind from the cooling fan 43, which has taken heat of the pressing roller 35, hitting the entrance guide 30b, the separating guide 30c, etc., heat is supplied from the pressing roller 35 to the entrance guide 30b, the separating guide 30c, etc. By this, it becomes possible to warm the whole of the fixing device 30. In other words, by causing heat to be moved from the pressing roller 35 to the fixing belt 31 and other members of the fixing device 30, it becomes possible to promote the heat storage as the whole of the fixing device 30.

A period for which the cooling fan 43 is caused to be operated during start-up of the fixing device 30, whether or not the cooling fan 43 is caused to be operated, or an air volume (air flow rate) of the cooling fan 43, etc. may be changed depending on the heat storing time (i.e., the heat storage index temperature). For example, the time for which the cooling fan 43 is caused to be operated during start-up of the fixing device 30 may be configured to be longer as the heat storing time is longer (i.e., as the heat storage index temperature is lower). As an example, the period for which the cooling fan 43 is caused to be operated during start-up of the fixing device 30 may be synchronized with the period for which the pressing roller 35 is brought into contact with the fixing belt 31. In addition, for example, the air volume of the cooling fan 43 during start-up of the fixing device 30 may be increased as the heat storing time is longer (i.e., as the heat storage index temperature is lower).

Here, the fan may be a fan which generates air flow inside a casing of the image forming apparatus 1 (printer portion 3), or a fan which discharges air from an inside to an outside of the casing or sucks air from the outside to the inside of the casing. In addition, a plurality of the fans may be provided. In addition, the air volume of the fan is, generally, represented by an air volume which can be sent per unit time (for example, m³/min), etc., however, the air volume may be represented by a rotation speed (or a number of rotations) of the fan.

Incidentally, the cooling fan 43 may be a fan which is capable of cooling at least one of the pressing roller 35 and the fixing belt 31. By causing the cooling fan 43 to be operated, which causes heat to be moved from at least one of the pressing roller 35 and the fixing belt 31 to the whole of the fixing device 30, it becomes possible to promote the heat storage as the whole of the fixing device 30.

In addition, during start-up of the fixing device 30, without bringing the pressing roller 35 into contact with the fixing belt 31, the cooling fan 43 may be caused to be operated. In this case as well, it becomes possible to cause heat from the fixing belt 31 to be moved as described above, and to promote the heat storage as the whole of the fixing device 30.

### Modified Example

The method of determining the heat storage state of the fixing device 30 by using the temperature of the stay 32 as the heat storage index temperature as described above is based on a fact that the stay 32 is not a member like the heating roller 37 which immediately heats the fixing belt 31. Therefore, in the present Embodiment, the example in which the temperature of the stay 32 is used as the heat storage index temperature is described, however, a temperature which may be used as the heat storage index temperature is not limited thereto. For example, as the heat storage index temperature, the following temperatures may be used. First, it is a temperature of a heating member, which is one of the plurality of heating members which heat the fixing belt 31 and of which heat capacity is larger than that of the heating roller 37. In addition, it is a temperature of a heating member, which is one of the plurality of heating members which heat the fixing belt 31, and of which a temperature rising speed of the fixing belt 31 by the heating member in a case in which a heat source which heats the heating member generates heat at a maximum heating amount is slower than the temperature rising speed of the fixing belt 31 by the heating roller 37 in the case in which the heat source which heats the heating roller 37 generates heat at the maximum heating amount. In addition, it is a temperature of a structural member which constitutes the fixing device 30 (typically a member to which a special heat source is not provided). In addition, it is an atmospheric temperature of the fixing device 30. From a viewpoint of accurately detecting the heat storage state of the fixing device 30, etc., it is preferable that the temperatures of these members and the atmospheric temperature are a temperature of a member which is present inside (in the area surrounded by the inner peripheral surface of) the fixing belt 31 and an atmospheric temperature inside the fixing belt 31.

In addition, regarding the detection of the temperature of the stay 32, influence of temperature distribution will be described. In the configuration of the present Embodiment, at a central portion of the stay 32 in the widthwise direction (a longitudinal direction of the stay 32) approximately perpendicular to the moving direction of the surface of the fixing belt 31, the stay 32 contacts substantially only the fixing pad 33. Therefore, at this central portion of the stay 32, exchange of heat occurs substantially only between the stay 32 and the fixing pad 33. On the other hand, in the configuration of the present Embodiment, at an end portion of the stay 32 in the widthwise direction of the fixing belt 31, the stay 32 contacts the structural members in addition to the fixing pad 33. Therefore, at this end portion of the stay 32, heat escapes from the stay 32 to the structural member, and a temperature thereof may decrease. In addition, in the configuration of the present Embodiment, a range in which the heater inside the stay 36a generates heat is mainly a range through which the recording material P passes, and no heat generating portion is present at this end portion of the stay 32. As a result, the temperature distribution of the stay 32 in the widthwise direction of the fixing belt 31 tends to be lower at the end portion than at the central portion. Therefore, in order to more accurately detect the heat storage state of the fixing belt 31 (in more detail, the heat storage state of the members inside the fixing belt 31), it is preferable to detect the temperature of the central portion of the stay 32 in the widthwise direction of the fixing belt 31. In the present Embodiment, the first temperature detecting element 39a is constituted by the plurality of temperature detecting elements provided at the plurality of positions in the widthwise direction of the fixing belt 31.

And in the present Embodiment, among the plurality of temperature detecting elements, a detection result by a temperature detecting element provided closest to the central portion in the widthwise direction of the fixing belt 31 is used to detect the heat storage state. However, it is not limited thereto, but as long as the detection result of the temperature detecting element and the heat storage state can be related with sufficient accuracy, a detection result by a temperature detecting element provided closer to the end portion in the widthwise direction of the fixing belt 31 may be used to detect the heat storage state.

### Effect

In this manner, in the present Embodiment, the fixing device 30 for fixing the toner image onto the recording material P includes the endless fixing belt 31, the heating member (heating roller) 37 which heats the fixing belt 31, the heat source (heater inside the heating roller) 36b which heats the heating member 37, the pressing member (pressing roller) 35 which forms the fixing nip portion N with the fixing belt 31 and nips and conveys the recording material P with the fixing belt 31 at the fixing nip portion N, a first output portion (the second temperature detecting element) 39b which outputs the signal corresponding to the temperature of the heating member 37, a second output portion (the first temperature detecting element) 39a which outputs the signal corresponding to the temperature of the detection target different from the heating member 37, and the control portion 5 which controls so as to change the operation setting of the fixing device 30, in which the fixing device 30 shifts from the state in which the heating of the heat source 36b is stopped to the state in which the toner image is capable of being fixed to the recording material P by the fixing belt 31 being heated by the heating member 37, in the period of the start-up of the fixing device 30 based on the signal outputted by the second output portion 39a.

Here, the control portion 5 may control so as to change the time from the start of the start-up to the completion of the start-up as the operation setting. In this case, the control portion 5 may control so as to set the time to a first time in a case in which the temperature indicated by the signal outputted by the second output portion 39a is a first temperature, and set the time to a second time longer than the first time in a case in which the temperature indicated by the signal outputted by the second output portion 39a is a second temperature lower than the first temperature. In addition, the control portion 5 may control so as to change the target temperature of the heating member 36b in the period of the start-up as the operation setting. In this case, the control portion 5 may control so as to set the target temperature to a first target temperature in a case in which the temperature indicated by the signal outputted by the second output portion 39a is a first temperature, and set the target temperature to a second target temperature higher than the first target temperature in a case in which the temperature indicated by the signal outputted by the second output portion 39a is a second temperature lower than the first temperature. In addition, the fixing device 30 may include the contact/separation mechanism 42 which brings the pressing member 35 into contact with and separated from the fixing belt 31, and the control portion 5 may control so as to change the setting of the operation of the contact/separation mechanism 42 in the period of the start-up as the operation setting. In this case, the control portion 5 may change the time required for bringing the pressing member 35 into contact with the fixing belt 31 in the period of the start-up as the operation setting, and control so as to set the time to a first time in a case in which the temperature indicated by the signal outputted by the second output portion 39a is a first temperature, and set the time to a second time longer than the first time in a case in which the temperature indicated by the signal outputted by the second output portion 39a is a second temperature lower than the first temperature. In addition, the fixing device 30 may include the air blowing mechanism (cooling fan) 43 which blows air toward at least one of the pressing member 35 and the fixing belt 31, and the control portion 5 may so as to change the setting of the operation of the air blowing mechanism 43 in the period of the start-up as the operation setting. In this case, the control portion 5 may change the time required for blowing the air by the air blowing mechanism 43 in the period of the start-up as the operation setting, and control so as to set the time to a first time in a case in which the temperature indicated by the signal outputted by the second output portion 39a is a first temperature, and set the time to a second time longer than the first time in a case in which the temperature indicated by the signal outputted by the second output portion 39a is a second temperature lower than the first temperature.

In addition, the fixing device 30 may include another heating member (pad portion) 34 which heats the fixing belt 31, and another heat source (heater inside the stay) 36a which heats another heating member 34, and the heat capacity of another heating member 34 is larger than the heat capacity of the heating member 37, and the second output portion 39a may be configured to output a signal corresponding to a temperature of another heating member 34. In this case, the heating member 37 may be constituted by a roller (heating roller) which stretches the fixing belt 31, and another heating member 34 may be configured so as to form the fixing nip portion N together with the pressing member 35. Typically, the heating member 37 and another heating member 34 are provided on the inner peripheral surface side of the fixing belt 31. Incidentally, the temperature rising speed of the fixing belt 31 by another heating member 34 in the case in which another heat source 36a generates heat at the maximum heating amount is slower than the temperature rising speed of the fixing belt 31 by the heating member 37 in the case in which the heat source 36b generates heat at the maximum heating amount, and the second output portion 39a may be configured to output the signal corresponding to the temperature of another heating member 34. In addition, the second output portion 39a may be configured to output a signal corresponding to the temperature of the structural member of the fixing device 30. Typically, this structural member is provided on the inner peripheral surface side of the fixing belt 31. In addition, the second output portion 39a may be configured to output a signal corresponding to the atmospheric temperature of the fixing device 30. At this time, typically, the second output portion 39a is configured to output a signal corresponding to the atmospheric temperature on the inner peripheral surface side of the fixing belt 31.

In addition, in the present Embodiment, the image forming apparatus 1 includes the image forming portion 100 which forms the toner image on the recording material P, and the fixing device 30 which fixes the toner image formed by the image forming portion 100 to the recording material P.

As described above, according to the present Embodiment, by determining the heat storage state of the fixing device based on the heat storage index temperature, it becomes possible to select the appropriate start-up sequence. Therefore, according to the present Embodiment, it becomes possible, corresponding to the heat storage state during start-up of the fixing device, to suppress the decrease in the fixing performance.

### Embodiment 2

Next, another Embodiment of the present invention will be described. Basic configurations and operations of an image forming apparatus in the present Embodiment are the same as those of the image forming apparatus in the Embodiment 1. Therefore, in the image forming apparatus in the present Embodiment, to those elements having functions or configurations which are the same as or corresponding to those of the image forming apparatus in the Embodiment 1, the same reference numerals as in the Embodiment 1 will be attached, and detailed description thereof will be omitted.

In the Embodiment 1, the control to change the operation setting of the fixing device 30 during start-up of the fixing device 30 based on the heat storage state (heat storage index temperature) of the fixing device 30 is described. In the present Embodiment, a control to change an operation setting of the fixing device 30 during fixing operation (in more detail, the target temperature of the heating roller 37) based on the heat storage state (heat storage index temperature) of the fixing device 30 will be described.

### <Temperature Adjusting Control of the Fixing Device During Fixing Operation Depending on the Heat Storage State>

A temperature adjusting control of the fixing device 30 during fixing operation depending on the heat storage state (heat storage index temperature) of the fixing device 30 in the present Embodiment, in other words, a control of the target temperature of the heating roller 37 during fixing operation will be described.

The stay 32 and the fixing pad 33 contact each other, and the fixing pad 33 and the fixing belt 31 contact each other (in more detail, contact via a sliding member). Therefore, in a case in which a temperature of the fixing pad 33 and the temperature of the stay 32 are lower than the temperature of the fixing belt 31, heat of the fixing belt 31 moves to the fixing pad 33 and the stay 32. Therefore, during fixing operation, in the case in which a temperature relationship therebetween is as described above, heat stored by the fixing belt 31 moves not only to the recording material P but also to the fixing pad 33 and the stay 32. As a result, the fixing performance may decrease.

Therefore, in the present Embodiment, the target temperature of the heating roller 37 during fixing operation is determined in consideration of the temperature of the fixing pad 33 and the stay 32. More specifically, in the present Embodiment, the temperature of the stay 32 at an arbitrary time point before the start of the fixing operation, in other words, the temperature detected by the first temperature detecting element 39a is used as a heat storage index temperature of the fixing device 30 upon starting the fixing operation. And, the target temperature of the heating roller 37 during fixing operation is determined based on the heat storage index temperature. For example, it may be configured that the lower the heat storage index temperature is, the higher the target temperature of the heating roller 37 during fixing operation is set to. By this, it becomes possible to appropriately control heat which is given to the recording material P during fixing operation.

In the present Embodiment, the temperature of the stay 32 detected by the first temperature detecting element 39a before the start of the fixing operation may be simply referred to as the “heat storage index temperature”.

Incidentally, a timing for acquiring the heat storage index temperature in the present Embodiment is, typically, upon the control portion 5 receiving the print information and starting the pre rotation (immediately after a start of the pre rotation, etc.). However, as it will be described below, as long as it is possible to relate the heat storage index temperature to the target temperature of the heating roller 37 during fixing operation in advance so that the target temperature of the heating roller 37 during fixing operation may be determined, the heat storage index temperature may be acquired at any timing before the time of the start of fixing operation. For example, similarly to the Embodiment 1, the temperature (initial temperature) of the stay 32 at the start of the start-up of the fixing device 30 may be used as the heat storage index temperature in the present Embodiment.

In this manner, in the present Embodiment, the target temperature of the heating roller 37, which controls the temperature of the fixing belt 31, is controlled by using not only the detection result of the temperature of the heating roller 37 but also the detection result of the temperature of the stay 32, which is a member different from the heating roller 37.

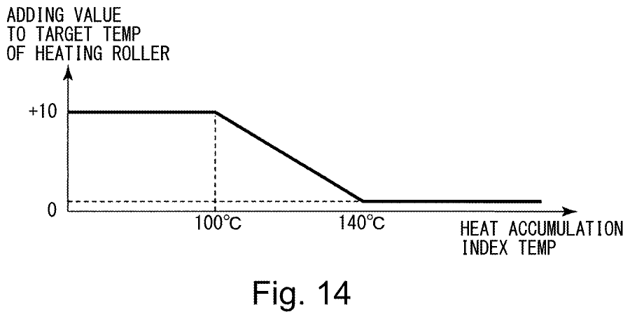

FIG. 14 is a graph view showing an example of a setting of the target temperature (an adding value to the target temperature set in advance) of the heating roller 37 during fixing operation depending on the heat storage index temperature. In the present Embodiment, in a case in which a heat storage state of the stay 32 is insufficient, a control to add the adding value, which is determined based on a relationship as shown in FIG. 14, to the target temperature of the heating roller 37 during fixing operation, which is set in advance corresponding to the type of the recording material P, is performed. In other words, in the present Embodiment, if the heat storage index temperature (Tstay) is lower than 100 °C, then the adding value to the target temperature set in advance is set to 10 °C. In addition, if the heat storage index temperature (Tstay) is 100 °C or higher and lower than 140 °C, then the adding value (Tadd) to the target temperature set in advance is a value calculated by the following equation: Tadd (°)=−0.25×Tstay+35.

In addition, if the heat storage index temperature is 140 °C or higher, the adding value to the target temperature set in advance is set to 0 °C (i.e., the adding value is not added to the target temperature set in advance). Here, a reason why the adding value is not added to the target temperature set in advance in the case in which the heat storage index temperature is 140 °C or higher is that, in the configuration in the present Embodiment, when the temperature of the stay 32 is 140 °C or higher, the heat storage is sufficient.

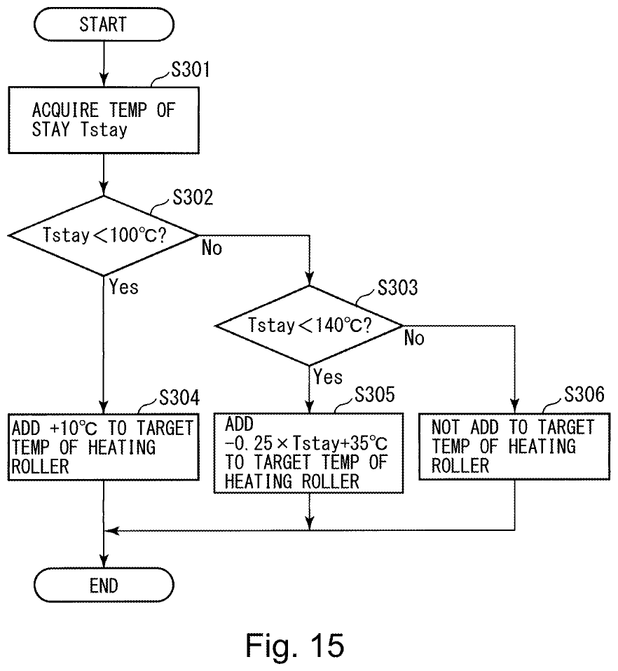

FIG. 15 is a flowchart diagram showing an outline of an example of the control to change the target temperature of the heating roller 37 during fixing operation. First, upon the print information being input and the pre rotation being started, the control portion 5 acquires a detection result of the temperature Tstay of the stay 32 by the first temperature detecting element 39a (S301). This temperature Tstay of the stay 32 is used as the heat storage index temperature.

Next, the control portion 5 determines whether or not the temperature Tstay of the stay 32 is lower than 100 °C (S302). If the control portion 5 determines that the temperature Tstay is lower than 100 °C in S302, then the control portion 5 controls so as to add 10 °C as the adding value Tadd to the target temperature of the heating roller 37 during fixing operation, which is set in advance correspondingly to the type of the recording material P (S304). If the control portion 5 determines that the temperature Tstay is not lower than 100 °C (i.e., 100 °C or higher), then the control portion 5 determines whether or not the temperature Tstay of the stay 32 is lower than 140 °C (i.e., whether or not the temperature Tstay is 100 °C or higher and lower than 140 °C) (S303). If the control portion 5 determines that the temperature Tstay is lower than 140 °C in S303, then the control portion 5 controls so as to add, to the target temperature set in advance, the addition value Tadd calculated by the following equation: Tadd (°C)=−0.25×Tstay+35 (S305). If the control portion 5 determines that the temperature Tstay is not lower than 140 °C (i.e., 140 °C or higher), then the control portion 5 controls not to add the adding value Tadd to the target value set in advance (i.e., set the adding value Tadd to 0 °C) (S306).

Incidentally, in the present Embodiment, a part of the adding value is calculated by the calculation equation, however, it is not limited thereto. For example, the adding value may be set in advance so as to be changed stepwise or continuously (linearly or curvilinearly) depending on the temperature of the stay 32. In addition, in a system in which influence of the process speed on the lowest point temperature is significant, the adding value may be changed for each process speed.

### <Change of an Adjusting Temperature of the Fixing Device During Fixing Operation>

During the fixing operation, the adding value to the target temperature of the heating roller 37 may be changed.

In the fixing device 30 in the present Embodiment, there is a possibility that the fixing performance decreases most at the lowest point temperature in the case in which the heat storage is insufficient. Therefore, in a manner of compensating for the insufficiency of the heat storage before the temperature of the heating roller 37 reaches the lowest point temperature, the addition of the adding value to the target temperature of the heating roller 37 is performed. More specifically, it is configured so that up to a number of passed sheets (number of printed sheets), at which the lowest point temperature is reached and which is obtained in advance through an experiment, etc., a control to add the adding value to the target temperature based on the heat storage index temperature is performed, and thereafter, the addition of the adding value to the target temperature is not performed. By this, it becomes possible to suppress that wasteful electric power is used in a latter half of a continuous sheet passing (continuous printing), that is, in a continuous sheet passing (continuous printing) after the lowest point temperature is reached.

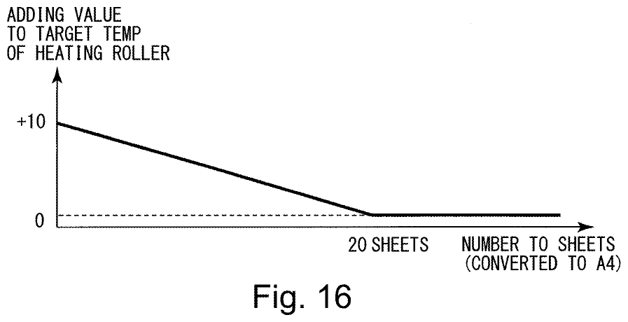

FIG. 16 shows, as an example, through the control described using FIG. 14 and FIG. 15, a transition of the adding value during fixing operation in the case in which it is determined that the adding value to the target temperature of the heating roller 37 is 10 °C based on the heat storage index temperature. As shown in FIG. 16, until the number of passed sheets reaches twenty sheets, the adding value may be changed so as to decrease as the number of passed sheets increases.

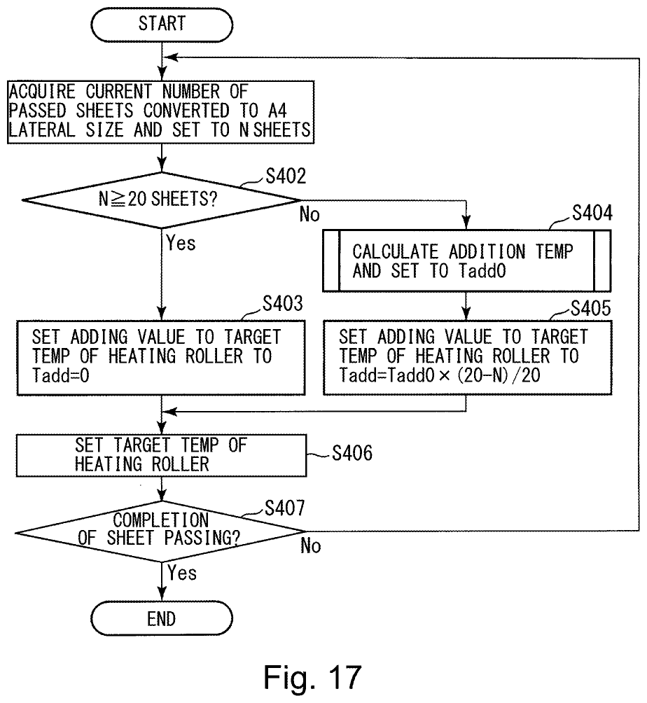

FIG. 17 is a flowchart diagram showing an outline of an example of a control to calculate the adding value to the target temperature of the heating roller 37 during fixing operation. First, during fixing operation, the control portion 5 acquires a current number of passed sheets (N sheets) (S401). Incidentally, the number of passed sheets may be obtained as a value converted into a predetermined size (for example, A4 lateral feeding size). Next, the control portion 5 determines whether or not the current number of passed sheets is twenty sheets or more (N≥20) (S402). If the control portion 5 determines that the current number of passed sheets is twenty sheets or more in S402, then the control portion 5 controls so as to set the adding value Tadd to the target temperature of the heating roller 37 during fixing operation, which is set in advance correspondingly to the type of the recording material P, to 0 °C (Tadd=0) (S403). On the other hand, if the control portion 5 determines that the number is not twenty sheets or more (i.e., less than twenty sheets) in S402, then the control portion 5 calculates an adding value Tadd0 corresponding to the temperature Tstay of the stay 32 in the same manner as described using FIG. 14 and FIG. 15 (S404). In addition, the control portion 5 controls so as to calculate the adding value Tadd to the target value, which is set in advance, by the following equation: Tadd=Tadd0×(20−N)/20 (S405). And the control portion 5 controls so as to set the target temperature of the heating roller 37 by adding the adding value Tadd, which is set in S403 or S405, to the target value, which is set in advance (S406). In addition, the control portion 5 repeats the operation described above until passing of all of the recording material P in a job (fixing operation) is completed (S407).

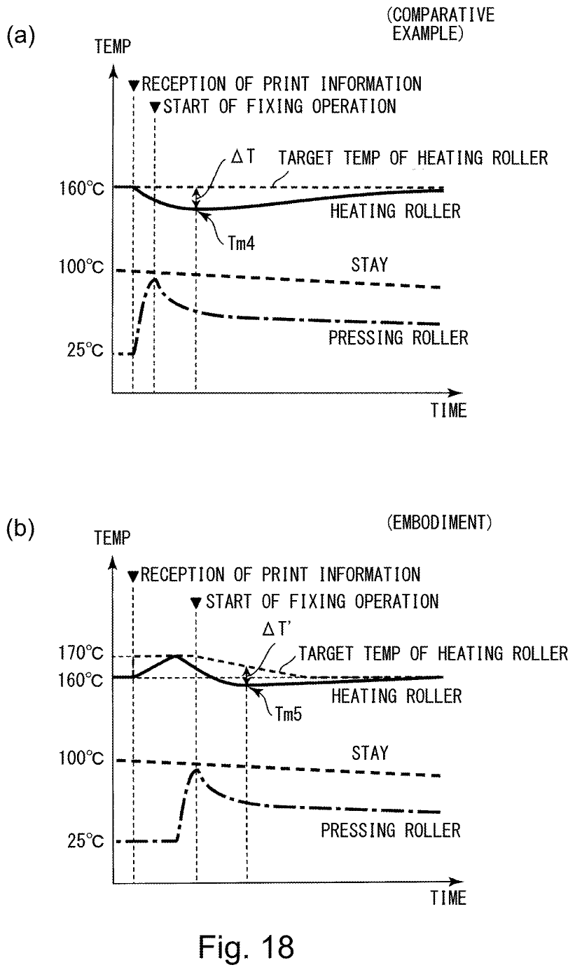

Part (a) of FIG. 18 is a graph view showing an example of a temperature transition of each member in a case in which, as a Comparative Example, without applying the control in the present Embodiment, the continuous printing (continuous sheet passing) is performed by starting the fixing operation in the state in which the heat storage of the stay 32 is insufficient. Part (b) of FIG. 18 is a graph view showing an example of the temperature transition of each member in a case in which, with applying the control in the present Embodiment, the continuous printing is performed by starting fixing operation in the state in which the heat storage of the stay 32 is insufficient. As shown in part (a) of FIG. 18, the lowest point temperature in the case in which the control of the present Embodiment is not applied is Tm4. On the other hand, as shown in part (b) of FIG. 18, in the case in which the control of the present Embodiment is applied, the lowest point temperature became Tm5 (>Tm4), and Tm5 is improved by approximately 5 °C with respect to Tm4. This is due to the following reason. That is, as to a temperature decreased amount at a time of the lowest point temperature relative to the target temperature of the heating roller 37, a value ΔT in the case in which the control of the present Embodiment is not applied and a value ΔT′ in the case in which the control is applied are substantially the same. Therefore, raising the target temperature of the heating roller 37 results in raising the lowest point temperature.

Incidentally, as to the adding value, it is not limited to being changed by using the calculation equation. For example, the adding value may be set in advance so as to be changed stepwise or continuously (linearly or curvilinearly) depending on the number of passed sheets. In addition, a relationship between the number of printed sheets and a changed amount of the adding value may be changed for each process speed.

In addition, the adding value to be added to the target temperature of the heating roller 37 during fixing operation may be uniformly determined in advance based on the temperature of the stay 32 at the start of the fixing operation, or may be determined based on the temperature of the stay 32 at any time during fixing operation. In addition, the addition of the adding value to the target temperature of the heating roller 37 during fixing operation may be performed until the number of passed sheets reaches the lowest point temperature, or may be continuously performed after the number of passed sheets reaches the lowest point temperature.

In addition, depending on the type of the recording material P to be passed, whether or not to perform the addition of the adding value to the target temperature of the heating roller 37 may be determined. Specifically, for example, in a case of the recording material P which is thin (of which the basis weight is small), with which acceptable fixing performance can be obtained even if the temperature of the heating roller 37 decreases, a selection such as not to perform the addition of the adding value to the target temperature of the heating roller 37 may be made. For example, in a case in which the recording material P is a plain paper and the basis weight thereof is 63 gsm or less, it may be configured that the control to add the adding value to the target temperature of the heating roller 37 based on the temperature of the stay 32 is not performed. And, in a case in which the recording material P is other than the plain paper having the basis weight of 63 gsm or less, it may be configured that the control to add the adding value is performed. In this case, for example, in a case in which the recording material P is a plain paper having the basis weight larger than 63 gsm, or in a case in which the recording material P is a recording material P, of which the fixing performance is lower than a plain paper, such as a coated paper and a thick paper, the control to add the adding value is performed. Incidentally, it may be configured that depending on the basis weight for each paper type category of the recording material P, whether or not to perform the control to add the adding value to the target temperature of the heating roller 37 is determined.

### Embodiment 3

Furthermore, another Embodiment of the present invention will be described.

Basic configurations and operations of an image forming apparatus in the present Embodiment are the same as those of the image forming apparatus in the Embodiment 1 and the Embodiment 2. Therefore, in the image forming apparatus in the present Embodiment, to those elements having functions or configurations which are the same as or corresponding to those of the image forming apparatus in the Embodiment 1 and the Embodiment 2, the same reference numerals as in the Embodiment 1 and the Embodiment 2 will be attached, and detailed description thereof will be omitted.

In the Embodiment 1, the control to change the operation setting of the fixing device 30 during start-up of the fixing device 30 based on the heat storage state (heat storage index temperature) of the fixing device 30 is described. In the Embodiment 2, the control to change the operation setting of the fixing device 30 (more specifically, the target temperature of the heating roller 37) during fixing operation based on the heat storage state (heat storage index temperature) of the fixing device 30 is described. In an Embodiment 3, a control to change a target temperature of the heating roller 310b based on a number of passed sheets of the fixing device 30 or a temperature of a stay 310a will be described.

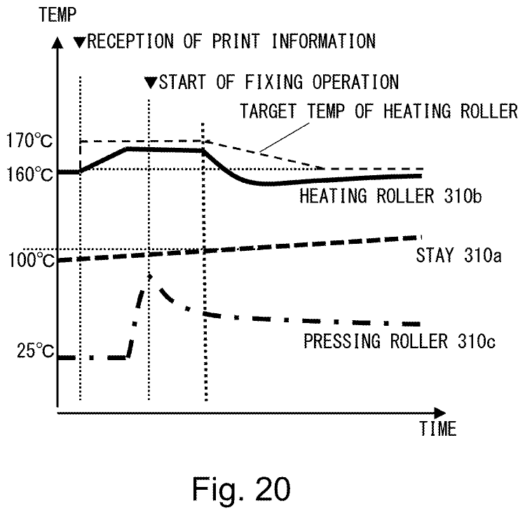

FIG. 20 is a graph view showing an example of a temperature transition of each member in a case in which, with applying the control of the present Embodiment, a continuous printing is performed by starting a fixing operation in a state in which a heat storage of the stay 310a is insufficient.

If the target temperature of the heating roller 310b is determined as in the flowchart diagram showing the outline of the example of the control to change the target temperature of the heating roller 37 during fixing operation described in FIG. 15, and the temperature of the stay 3120a is less than 100 °C, then the target temperature of the heating roller 310b is raised by 10 ° C. When the target temperature raised by 10 °C is reached, the fixing device 30 starts the fixing operation, and continuous sheet passing is performed.

Here, during sheet passing, if it is detected that the temperature of the stay 310a becomes a predetermined temperature or higher, then the target temperature is changed from the temperature raised by 10 °C to a normal target temperature.

This is because, in the case in which the heat storage of the stay 310a is insufficient, a problem is that the temperature of the fixing belt becomes insufficient and the fixing performance is decreased while passing a predetermined number of the recording material P after starting the fixing operation, therefore by returning the target temperature to the normal target temperature, which is determined corresponding to the recording material P to be passed, when it is detected that the temperature of the stay 310a becomes the predetermined temperature or higher, it becomes possible, while ensuring the fixing performance, to improve energy saving performance. In addition, in FIG. 20, as for a timing for changing the target temperature from the temperature raised by 10 °C to the normal target temperature, it may be configured that based on a passing of a predetermined number of sheets, the change is performed.

In the case in which the heat storage of the stay 310a is insufficient, a problem is that the temperature of the fixing belt becomes insufficient while passing a predetermined number of the recording material P after starting the fixing operation, therefore it may be configured with regarding that the heat storage is done in the stay 310a to some extent after a predetermined number of sheets such as five sheets, for example, have passed.

### Modified Example

As described in the Embodiment 1, also in the present Embodiment, a temperature which may be used as the heat storage index temperature for determining the heat storage state is not limited to the temperature of the stay 310a. Various types of temperatures as described in the Embodiment 1 may be used as the heat storage index temperature.

In addition, similarly to the Embodiment 1, also in the present Embodiment, among the plurality of temperature detecting elements constituting the first temperature detecting element 39a, the detection result by the temperature detecting element provided closest to the central portion in the widthwise direction of the fixing belt 31 is used to detect the heat storage state. However, it is not limited thereto, but as described in the Embodiment 1, the detection result by the temperature detecting element provided closer to the end portion in the widthwise direction of the fixing belt 31 may be used to detect the heat storage state.

### Effect

In this manner, in the present Embodiment, the control portion 5 controls so as to change the target temperature of the heating member (heating roller) 37 during the fixing operation in which the recording material P is passing through the fixing nip portion N based on a signal outputted by a second output portion (first temperature detecting element) 39a. In addition, in the present Embodiment, the control portion 5 controls so that in a case in which a temperature indicated by the signal outputted by the second output portion 39a is a first temperature, the target temperature is set to a first target temperature, and in a case in which the temperature indicated by the signal outputted by the second output portion 39a is a second temperature lower than the first temperature, the target temperature is set to a second target temperature higher than the first target temperature. In addition, in the present Embodiment, the control portion 5 controls, in a period from receiving the print information until the recording material P reaches the fixing nip portion N, so as to change the target temperature based on the signal outputted by the second output portion 39a. In addition, the control portion 5 may control so that after receiving the print information, a target temperature when a first recording material, which reaches the fixing nip portion N first, is passing through the fixing nip portion N is set to a first target temperature, and a target temperature when a second recording material, which reaches the fixing nip portion N after the first recording material, is passing through the fixing nip portion N is set to a second target temperature lower than the first target temperature.

As described above, according to the present Embodiment, by determining the heat storage state of the fixing device based on the heat storage index temperature, it becomes possible to set an appropriate target temperature of the heating roller during fixing operation. Therefore, according to the present Embodiment, it becomes possible, corresponding to the heat storage state during start-up of the fixing device, to suppress the decrease in the fixing performance.

### OTHER EMBODIMENTS

As described above, the present invention has been described according to the specific Embodiments, however, the present invention is not limited to the Embodiments described above.

In the Embodiments described above, the fixing device 30 includes the two heating members of the heating roller 37 and the stay 32 (pad portion 34) as the heating member, however, the fixing device 30 may include three or more heating members. In this case as well, it is possible to perform the control according to the Embodiments described above. In this case, for example, a temperature of a heating member of which a heat capacity is largest or of a heating member of which a speed of raising the temperature of the fixing belt 31 in a case of generating heat at a maximum heating amount is slowest may be used as the heat storage index temperature.

In addition, at least one of the heating members which heats the fixing belt may be provided on the outer peripheral surface side of the fixing belt.

In addition, the temperature adjusting control of the heating member may be performed by an ON/OFF time division control of the heater, a phase control, etc.

In addition, in the Embodiments described above, the image forming apparatus is a color image forming apparatus, however, the present invention may also be applied to, for example, a monochrome image forming apparatus of a single color of black. According to the present invention, it becomes possible, corresponding to the heat storage state of the fixing device, to suppress the decrease in the fixing performance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2025-073788, filed Apr. 26, 2025 and 2026-069112, filed Apr. 18, 2026, which are hereby incorporated by reference herein in their entirety.

What is claimed is:

1. A fixing device for fixing a toner image onto a recording material, the fixing device comprising:
an endless fixing belt;
a heating member configured to heat the belt;
a heat source configured to heat the heating member;
a pressing member configured to form a fixing nip portion with the fixing belt and to nip and convey the recording material with the fixing belt at the fixing nip portion;
a first output portion configured to output a signal corresponding to a temperature of the heating member;
a second output portion configured to output a signal corresponding to a temperature of a detection target different from the heating member; and
a controller configured to control so as to change an operation setting of the fixing device, in which the fixing device shifts from a state in which heating of the heat source is stopped to a state in which the toner image is capable of being fixed to the recording material by the fixing belt being heated by the heating member, in a period of start-up of the fixing device based on the signal outputted by the second output portion.

2. The fixing device according to claim 1, wherein the controller controls so as to change a time from start of the start-up to completion of the start-up as the operation setting.

3. The fixing device according to claim 2, wherein the controller controls so as to set the time to a first time in a case in which a temperature indicated by the signal outputted by the second output portion is a first temperature, and set the time to a second time longer than the first time in a case in which the temperature indicated by the signal outputted by the second output portion is a second temperature lower than the first temperature.

4. The fixing device according to claim 1, wherein the controller controls so as to change a target temperature of the heating member in the period of the start-up as the operation setting.

5. The fixing device according to claim 4, wherein the controller controls so as to set the target temperature to a first target temperature in a case in which a temperature indicated by the signal outputted by the second output portion is a first temperature, and set the target temperature to a second target temperature higher than the first target temperature in a case in which the temperature indicated by the signal outputted by the second output portion is a second temperature lower than the first temperature.

6. The fixing device according to claim 1, further comprising a contact/separation mechanism configured to bring the pressing member into contact with and separated from the fixing belt,
wherein the controller controls so as to change a setting of an operation of the contact/separation mechanism in the period of the start-up as the operation setting.

7. The fixing device according to claim 6, wherein the controller changes a time required for bringing the pressing member into contact with the belt in the period of the start-up as the operation setting, and controls so as to set the time to a first time in a case in which a temperature indicated by the signal outputted by the second output portion is a first temperature, and set the time to a second time longer than the first time in a case in which the temperature indicated by the signal outputted by the second output portion is a second temperature lower than the first temperature.

8. The fixing device according to claim 1, further comprising an air blowing mechanism configured to blow air toward at least one of the pressing member and the fixing belt,
wherein the controller controls so as to change a setting of an operation of the air blowing mechanism in the period of the start-up as the operation setting.

9. The fixing device according to claim 8, wherein the controller changes a time required for blowing the air by the air blowing mechanism in the period of the start-up as the operation setting, and controls so as to set the time to a first time in a case in which a temperature indicated by the signal outputted by the second output portion is a first temperature, and set the time to a second time longer than the first time in a case in which the temperature indicated by the signal outputted by the second output portion is a second temperature lower than the first temperature.

10. A fixing device for fixing a toner image onto a recording material, the fixing device comprising:
an endless belt;
a heating roller configured to stretch the belt and heat the belt;
a pressing roller;
a nip forming member configured to form a nip with the pressing roller;
a supporting member configured to support the nip forming member;
a detecting portion configured to detect a temperature of the supporting member; and
a controller configured to control a heater incorporated in the heating roller,
wherein the controller controls a target temperature of the heater so as to become higher in a case in which a temperature of the supporting member detected by the detecting portion is lower than a predetermined temperature than in a case in which the temperature of the supporting member detected by the detecting portion is equal to or higher than the predetermined temperature.

11. The fixing device according to claim 10, wherein the controller controls to start a fixing operation when a temperature of the heating roller reaches the target temperature set to higher in the case in which the temperature of the supporting member detected by the detecting portion is lower than the predetermined temperature.

12. The fixing device according to claim 10, wherein the target temperature in the case in which the temperature of the supporting member detected by the detecting portion is equal to or higher than the predetermined temperature is a temperature determined based on the recording material.

13. The fixing device according to claim 10, wherein when the detecting portion detects that the temperature of the supporting member becomes equal to or higher than the target temperature, the controller returns the target temperature from the target temperature set to higher to a temperature determined corresponding to a recording material to be passed through.

14. The fixing device according to claim 10, wherein when a predetermined number of the recording materials are passed through the nip, the controller returns the target temperature from the target temperature set to higher to a temperature determined corresponding to a recording material to be passed through.
